(19) United States
(12) Patent Application Publication
(10) Pub. No.: US 2013/0209705 A1
(43) Pub. Date: Aug. 15, 2013

(54) ELECTRICAL DISCHARGE SURFACE TREATMENT METHOD

(71) Applicants: Akihiro Goto, Tokyo (JP); Nobuyuki Sumi, Tokyo (JP); Yusuke Yasunaga, Tokyo (JP); Hiroyuki Teramoto, Tokyo (JP)

(72) Inventors: Akihiro Goto, Tokyo (JP); Nobuyuki Sumi, Tokyo (JP); Yusuke Yasunaga, Tokyo (JP); Hiroyuki Teramoto, Tokyo (JP)

(73) Assignee: MITSUBISHI ELECTRIC CORPORATION, Tokyo (JP)

(21) Appl. No.: 13/140,604

(22) PCT Filed: Sep. 16, 2010
(86) PCT No.: PCT/JP2010/005652

§ 371 Date: Jul. 15, 2011

(51) Int. Cl. H01B 13/00

(52) U.S. Cl. CPC H01B 13/00
USPC 427/580

(57) ABSTRACT

There is an electrical discharge surface treatment method of forming a surface layer on a work piece surface by making pulsed electrical discharge repeatedly occur between a work piece (2) and an electrode (1) for electrical discharge surface treatment, for which a compact formed by powder obtained by mixing 20 wt % or more of silicon with powder of a hard material or a solid body of silicon is used, so that the electrode material is moved to the work piece (2), including: a processing time decision step of observing an electrical discharge treatment surface formed on the work piece surface by the electrical discharge and deciding the electrical discharge surface treatment end time in a process where surface roughness formed by the electrical discharge on the electrical discharge treatment surface acquired from the observation result is increased and is then decreased. Electrical discharge surface treatment between the electrode and the work piece is executed for only the processing time set in the processing time decision step.

### TECHNICAL FIELD

The present invention relates to electrical discharge surface treatment for forming a film or a surface layer, which is formed of an electrode material or a material formed by reaction of an electrode material with electrical discharge energy, on a base material surface.

### BACKGROUND ART

A technique of forming an amorphous alloy layer or a surface layer with a fine crystal structure on a work piece surface by performing electrical discharge machining, such that some electrode materials move to the work piece surface in liquid or hydrocarbon gas, using silicon as an electrode for electrical discharge is disclosed in JP-H05-13765-B. (Patent Document 1)

### RELATED ART DOCUMENT

### Citation List

[Patent Document 1] Japanese Examined Patent Application Publication No. H05-13765-B

### SUMMARY OF INVENTION

### Problem that the Invention is to Solve

Patent Document 1 discloses that an Si surface layer, which gives corrosion resistance to the work piece surface, can be formed by performing electrical discharge using Si as an electrode. However, since it takes 2 hours to process a thickness of about 3 μm in the area of φ20 mm, the processing time becomes very long. In addition, since there is also a problem in that a surface layer portion is recessed by about 100 μm at the time of processing, practical use is generally difficult. In addition, it was found that the corrosion resistance could not be practically acquired in all cases and it could be used only for limited applications.

For example, evaluation using a cold die steel SKD11 material was performed in order to apply it to a mold or the like. When processing was performed for 2 hours in the area equivalent to the area of φ20 mm, corrosion occurred and expected effects were not acquired.

Moreover, although effects, such as a long life, have been reported during execution of press molding, turret punch, and the like by an electrical discharge surface treatment using an electrode for electrical discharge surface treatment, there are also similar problems including a long processing time and high surface roughness. Moreover, since there is no clear indicator for determination regarding in which state the processing ends and this depends on the field, it cannot be denied that there are many process variations.

The present invention has been made in view of such a situation, and it is an object of the present invention to provide an electrical discharge surface treatment method capable of forming a surface layer with excellent corrosion resistance and erosion resistance.

### Means for Solving the Problem

An electrical discharge surface treatment method related to the present invention is an electrical discharge surface treatment method of forming a surface layer on a work piece surface by making pulsed electrical discharge repeatedly occur between a work piece and an electrode for electrical discharge surface treatment, for which a compact formed by powder obtained by mixing 20 wt % or more of silicon with powder of a hard material or a solid body of silicon is used, so that the electrode material is moved to the work piece and includes a processing time decision step of observing an electrical discharge treatment surface formed on the work piece surface by the electrical discharge and deciding the electrical discharge surface treatment end time in a process where surface roughness formed by the electrical discharge on the electrical discharge treatment surface acquired from the observation result is increased and is then decreased. It is characterized in that electrical discharge surface treatment between the electrode and the work piece is executed for only the processing time set in the processing time decision step.

### Advantageous Effects of Invention

According to the present invention, since it is possible to stably form a high-quality film on a work piece by electrical discharge using an Si electrode, a surface layer which exhibits high corrosion resistance and erosion resistance can be formed.

### BRIEF DESCRIPTION OF DRAWINGS

FIG. 1 is an explanatory view of an electrical discharge surface treatment system.

FIG. 2 is a view showing voltage and current waveforms in electrical discharge surface treatment.

FIG. 3 is a view showing an electrical discharge phenomenon.

FIG. 4 is a view showing the relationship among resistance R, resistivity p, area S, and length L of an electrode.

FIG. 5 is a view showing a current waveform when electrical discharge cannot be detected.

FIG. 6 is a view showing an analysis result of a surface layer containing Si.

FIG. 7 is an explanatory view of a corrosion test.

FIG. 8 is a schematic view of an evaluation test of erosion resistance.

FIG. 9 is a view showing an evaluation test result of a stainless steel base material.

FIG. 10 is a view showing an evaluation test result of Stellite.

FIG. 11 is a view showing an evaluation test result of a TiC film.

FIG. 12 is a view showing an evaluation test result of an Si surface layer.

FIG. 13 is a view showing an evaluation test result of an Si surface layer.

FIG. 14 is a table of conditions of the Si surface layer.

FIG. 15 is a photograph showing a state where an Si surface layer is broken.

FIG. 16 is a photograph showing an erosion state of Stellite.

FIG. 17 is a characteristic view of erosion resistance of the Si surface layer.

FIG. 18 is a photograph when an Si surface layer has been cracked.

FIG. 19 is a characteristic view of erosion resistance of the Si surface layer.

FIG. 20 is a characteristic view of erosion resistance of the Si surface layer.

FIG. 21 is a photograph of a 2 μm surface layer.

FIG. 22 is a photograph of a 2 μm surface layer (after corrosion).

FIG. 23 is a photograph of a 10 μm surface layer.

FIG. 24 is a photograph of a 10 μm surface layer (after corrosion).

FIG. 25 is a surface photograph of an Si surface layer.

FIG. 26 is a cross-sectional photograph of an Si surface layer.

FIG. 27 is an explanatory view of the principle of a change in surface roughness.

FIG. 28 is a graph of a change in surface roughness.

FIG. 29 is a graph of a change in surface roughness.

FIG. 30 is an explanatory view of definition of a film thickness of an Si film in the related art.

FIG. 31 is an X-ray diffraction image of an Si surface layer.

FIG. 32 is a characteristic view showing the relationship between the Si mixture ratio of an electrode and the film surface roughness.

FIG. 33 is a characteristic view showing the relationship between the Si mixture ratio of an electrode and the film hardness.

FIG. 34 is a characteristic view showing the relationship between the Si mixture ratio of an electrode and the film Si concentration.

FIG. 35 is a SEM photograph of a TiC film surface.

FIG. 36 is a SEM photograph of a TiC film surface in which Si is mixed.

FIG. 37 is a SEM photograph of a TiC film surface in which Si is mixed.

FIG. 38 is a SEM photograph of a TiC film surface in which Si is mixed.

FIG. 39 is a SEM photograph of an Si film surface.

FIG. 40 is an X-ray diffraction pattern measurement result from a direction of a TiC film surface in which Si is mixed.

FIG. 41 is a characteristic view showing the relationship between the Si mixture ratio of an electrode and the film Ti concentration.

FIG. 42 is a characteristic view showing the relationship between the Si mixture ratio of an electrode and the erosion resistance.

FIG. 43 is an observation result of a surface state of a film after spraying a water jet.

FIG. 44 is a characteristic view showing the relationship between the Si mixture ratio of an electrode and the corrosion resistance.

FIG. 45 is an observation result of a surface state of a film after aqua regia immersion.

FIG. 46 is a view showing the relationship between the Si mixture ratio (ratio by weight) in an electrode and each film characteristic.

FIG. 47 is a graph of a change in surface roughness.

### DESCRIPTION OF EMBODIMENTS

Hereinafter, embodiments of the present invention will be described using the drawings.

### First Embodiment

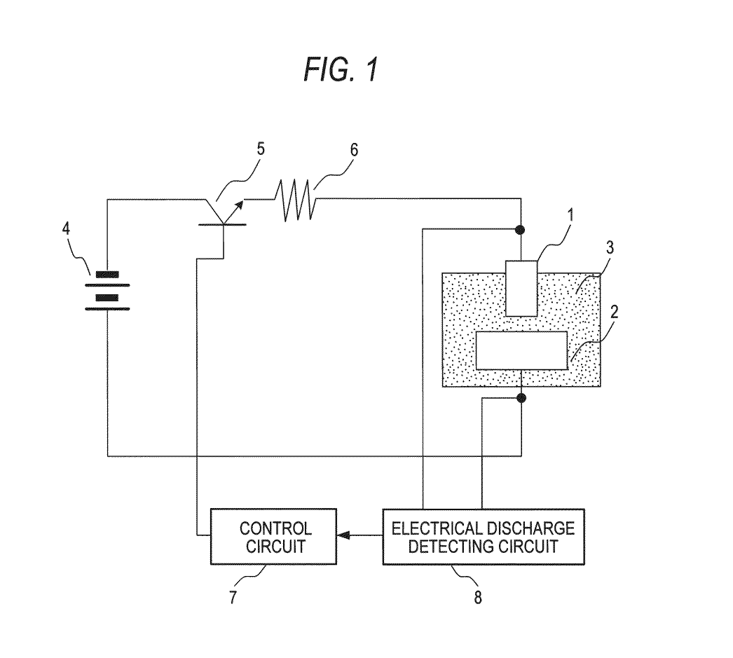

The outline of an electrical discharge surface treatment method of forming a structure with a function of erosion resistance on a work piece surface by making pulsed electrical discharge occur between a silicon electrode and the work piece is shown in FIG. 1.

In the drawing, 1 denotes a solid-shaped metal silicon electrode (hereinafter, referred to as an Si electrode), 2 denotes a work piece to be processed, 3 denotes oil which is a machining fluid, 4 denotes a DC power supply, 5 denotes a switching element for applying or stopping a voltage of the DC power supply 4 between the Si electrode 1 and the work piece 2, 6 denotes a current limiting resistor for controlling the current value, 7 denotes a control circuit for controlling ON/OFF of the switching element 5, and 8 denotes an electrical discharge detecting circuit for detecting that electrical discharge has occurred by detecting a voltage between the Si electrode 1 and the work piece 2.

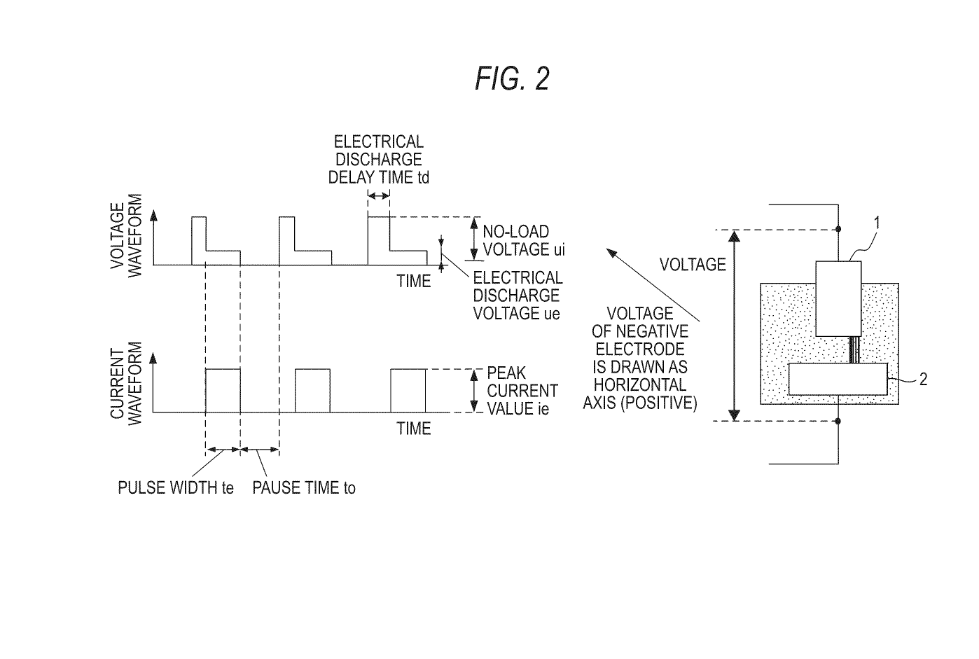

Next, the operation will be described using FIG. 2 in which voltage and current waveforms are shown.

By turning on the switching element 5 by the control circuit 7, a voltage is applied between the Si electrode 1 and the work piece 2. A distance between the Si electrode 1 and the work piece 2 is controlled by an electrode feed mechanism (not shown) so as to be a suitable distance (distance within which electrical discharge occurs), and electrical discharge occurs between the Si electrode 1 and the work piece 2 after a while. A current value ie or a pulse width to (electrical discharge duration) of a current pulse or an electrical discharge pause time “to” (time for which a voltage is not applied) is set in advance, and is decided by the control circuit 7 and the current limiting resistor 6.

If electrical discharge occurs, the electrical discharge detecting circuit 8 detects the occurrence of electrical discharge at a timing where a voltage between the Si electrode 1 and the work piece 2 is reduced, and the control circuit 7 turns off the switching element 5 in a predetermined time (pulse width “te”) after detecting the occurrence of electrical discharge.

In a predetermined time (pause time “to”) after turning off the switching element 5, the switching element 5 is turned on again by the control circuit 7.

By repeating the above-described operation, electrical discharge of a current waveform can be made to occur continuously.

In addition, although the switching element is drawn as a transistor in FIG. 1, other elements may also be used as long as they are elements capable of controlling the application of a voltage. In addition, although the control of a current value is performed by a resistor in the drawing, other methods may also be used as long as the current value can be controlled.

In addition, although the waveform of a current pulse is set as a rectangular wave in the explanation of FIG. 2, it is needless to say that other waveforms can be used. Although it is possible to supply more of the Si material by using more electrode according to the form of a current pulse or it is possible to use a material effectively by reducing the consumption of an electrode, a detailed explanation thereof is not made in this specification.

By making electrical discharge between the Si electrode 1 and the work piece 2 occur continuously as described above, a layer containing a large amount of Si can be formed on the surface of the work piece 2.

However, not necessarily all kinds of Si are satisfactory in order to stably form a high-quality Si containing layer according to the purpose, and there are also conditions required for the circuit shown in FIG. 1.

First, before explaining the conditions of an Si electrode and a circuit, a film forming technique using electrical discharge machining will be described in order to clarify the difference between the conventional technique regarding electrical discharge surface treatment and the present embodiment.

A method of forming an amorphous alloy layer or a high corrosion-resistant and high heat resistant surface layer, which has a fine crystal structure, on the work piece surface using silicon as an electrode for electrical discharge machining is disclosed in Patent Citation 1.

In the electrical discharge machining in the Si electrode disclosed in Patent Citation 1, processing is performed for several hours in an area of φ20 mm by supplying energy with a peak value Ip of 1 A using a circuit system of turning on and off a voltage periodically under the conditions where a voltage application time and a pause time are fixed to 3 μs and 2 μs, respectively.

For this reason, in a period of 3 μs for which a voltage is applied, the locations of the occurrence of electrical discharge in voltage pulses are all different. Accordingly, the current pulse width in which a current flows, which is an actual continuous electrical discharge time, changes in a sequential manner. As a result, stable film formation becomes difficult.

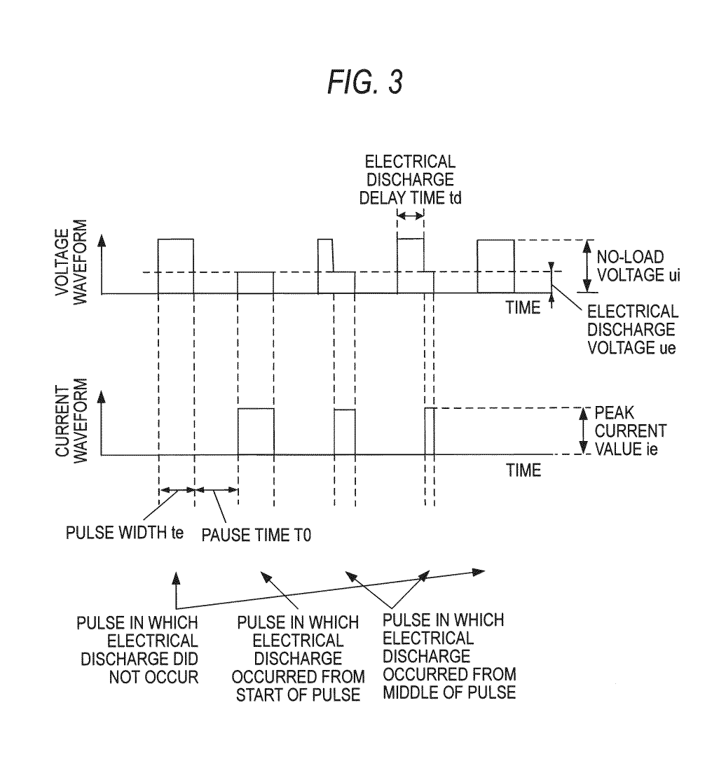

For example, as illustrated in FIG. 3, in a power supply using a circuit method of turning a voltage on and off periodically, a voltage waveform and a current waveform change to cause a phenomenon in which energy of each pulse is different occurs. Accordingly, since the amount of Si, which is an electrode material, supplied to the work piece and energy used to form a surface layer by melting the surface of the work piece becomes varied, stable processing becomes difficult.

In addition, although both an electrical discharge voltage and an electrical discharge current are constant in the drawing, both the voltage and the current change in practice. In addition, when a high-resistance material, such as Si, is used as an electrode, it becomes a voltage involving a part of a voltage drop in the Si. Accordingly, the voltage is high and the fluctuation also becomes large.

Next, the reason why the voltage is turned on and off periodically as described above in Patent Citation 1 will be described.

In Patent Citation 1, silicon which is a high-resistance material with a specific resistance of about 0.01 Ωcm is used, and the conditions of a very small current pulse are used.

For this reason, in the conventional control method of detecting the occurrence of electrical discharge by detecting the arc electric potential of electrical discharge, a voltage of a voltage drop when a current flows through an Si electrode becomes a value added to the arc electric potential of electrical discharge at the time of occurrence of electrical discharge when the electrode is a high-resistance material. When the voltage of a voltage drop is high, the circuit cannot recognize the occurrence of electrical discharge even though the electrical discharge has occurred.

Moreover, a silicon film based on the conventional electrical discharge machining has a problem in that it is not stable because of a large variation in processing.

The problem is also caused by the Si having high resistance.

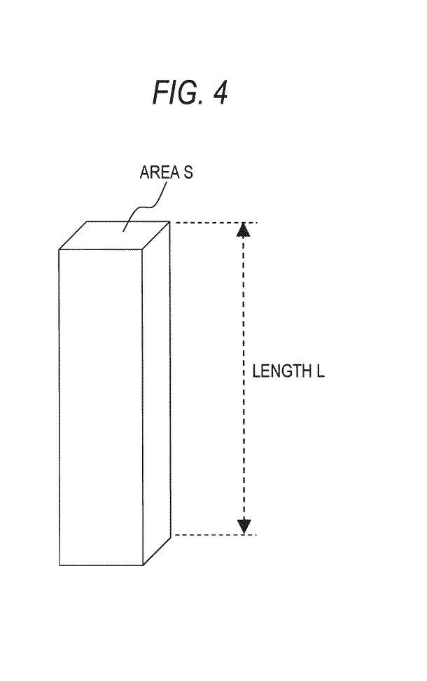

For example, assuming that the resistivity, area, and length of an electrode are ρ, S, and L as shown in FIG. 4, the resistance R of the electrode is expressed as R=ρ·L/S.

However, by the method of supplying power to an electrode, that is, by the electrode holding hold, the value of R varies greatly when p is large.

In the related art, silicon with a resistance of about ρ=0.01 Ωcm is used as an electrode. However, in the case of such a high-resistance material, unconditional processing is not possible. For example, when an Si electrode is long and electric power is supplied through one end, the resistance of the electrode becomes high if the electrode is long and the resistance becomes low as the electrode becomes short. When the electrode is long and the resistance is high accordingly, electrical discharge cannot be detected as described above. For this reason, a probability that an abnormal pulse will be generated becomes high. Even if an abnormal pulse is not generated, the current value of electrical discharge becomes low because the resistance is high.

In the study of the inventors, when silicon with a resistance of about ρ=0.01 Ωcm was used as an electrode, there was a case where a voltage drop in the electrode due to a current when electrical discharge occurred if the electrode length became as large as about several tens of millimeters or more and accordingly, unusual electrical discharge occurred and the formation of a normal surface layer was difficult.

In addition, it was found that the conditions, in which such abnormal electrical discharge occurred, were mostly decided by the power supply position and the position of discharge, that is, by the length of an electrode and the area (thickness) of the electrode was seldom related.

Presumably, this is because a current does not flow through the whole cross section of an electrode uniformly but flows through a certain thin path when the current flows through the electrode. Accordingly, it becomes possible to make stable electrical discharge occur by making the position, at which the electrical discharge occurs, and the power supply point close to each other even if silicon with a resistivity of about 0.01 Ωcm is used. For example, if electric power is supplied in a state where about 1 mm of plate-like silicon is bonded to metal, stable electrical discharge was possible even when the resistance was 0.05 Ωcm. Even in the electrode of 0.01 Ωcm, however, when it became a predetermined length or more, for example, a length of about 100 mm or more, abnormal electrical discharge occurred often. As a result, stable processing was difficult.

As discussed above, the following factors became clear from the experiments of the inventors.
In order to form a surface layer containing Si on the surface of a work piece at high speed and with a thickness of about 10 μm so that it can be industrially used by using pulse discharge in oil with silicon as an electrode, it is not possible to use the method disclosed in the related art, and a circuit based on the method of controlling the pulse width (discharged current pulse) of electrical discharge as shown in FIGS. 1 and 2 (using a control to have almost the same pulse width) should be used and a pulse of appropriate energy should be used.
In order to form a surface layer of about 10 μm on the work piece surface using silicon as an electrode, it is preferable that the resistance (resistivity) is low. If the case where an electrode with a length of 100 mm or more is used is assumed in consideration of industrial practical use, it is preferable that p is about 0.005 Ωcm or less. In order to reduce the resistance of Si, it is preferable to increase the concentration of so-called impurities, such as doping other elements.
Even if ρ is equal to or larger than 0.005 Ωcm, stable processing is possible when the power supply point and the electrical discharge position are close to each other. Preferably, the index in this case is set as follows including the case where ρ is equal to or smaller than 0.005 Ωcm. If the following method is adopted, the processing may be possible even when p is about 0.02 Ωcm.

That is, when forming a surface layer containing Si on the work piece surface with the Si as an electrode using a power supply which recognizes electrical discharge by a drop in a voltage applied between electrodes and stops the voltage application (that is, stops electrical discharge) after a predetermined time (pulse width te) elapses from the point of time when the electrical discharge occurred, it is preferable to perform processing in a state where a voltage between electrodes including a voltage drop in the Si electrode, which is a resistor when electrical discharge occurs, is lower than the electrical discharge detection level.

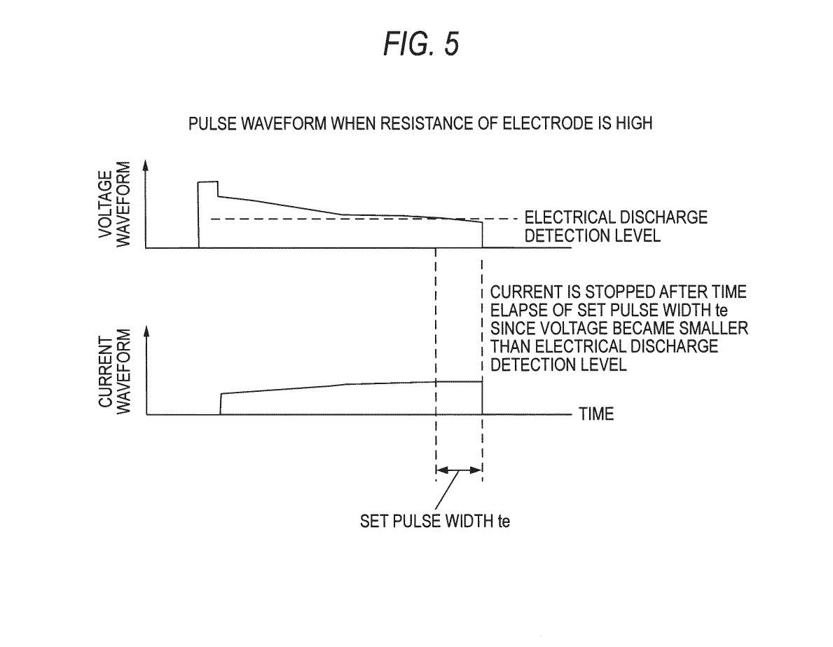

Although the electric potential of an arc is generally about 25 V to 30 V, it is preferable to set the voltage of the electrical discharge detection level to be lower than the power supply voltage and to be higher than the electric potential of the arc. However, if the electrical discharge detection level is set to be low, a risk increases that an abnormally long pulse will be generated as shown in FIG. 5 because the occurrence of electrical discharge cannot be recognized even if the electrical discharge occurs if the resistance of Si is not set to be low.

If the electrical discharge detection level is set to be high, it easily becomes less than the electrical discharge detection level when electrical discharge occurs even if the resistance of Si is slightly high. That is, it is preferable to make the electrode long when the resistance of Si is low and to shorten the length of Si when the resistance of Si is high so that a voltage between electrodes when electrical discharge occurs becomes lower than the electrical discharge detection level. Although the electrical discharge detection level may be set to be lower than the power supply voltage and higher than the electric potential of an arc, it is preferable to set it to a level slightly lower than the power supply voltage from the above explanation.

In the experiments of the inventors, it was found that setting the electrical discharge detection level to a lower value than the voltage of a main power supply by about 10 V to 30 V was practically effective. More strictly, setting the electrical discharge detection level to a lower value than the power supply voltage by about 10 V to 20 V was good since the range of Si that could be used was extended. The main power supply referred to herein is a power supply which supplies a current for the occurrence and continuation of electrical discharge, but is not a power supply of a high voltage superposition circuit which applies a high voltage for the occurrence of electrical discharge (details thereof are not discussed herein).

If the above conditions are satisfied, stabilization can be achieved, and an electrical discharge pulse can be generated freely and stably using Si, which is a high-resistance material, as an electrode. As a result, a surface layer containing Si can be formed on a work piece.

Meanwhile, the surface layer containing Si described above was formed, and the characteristics were examined. As a result, the following factors were found.

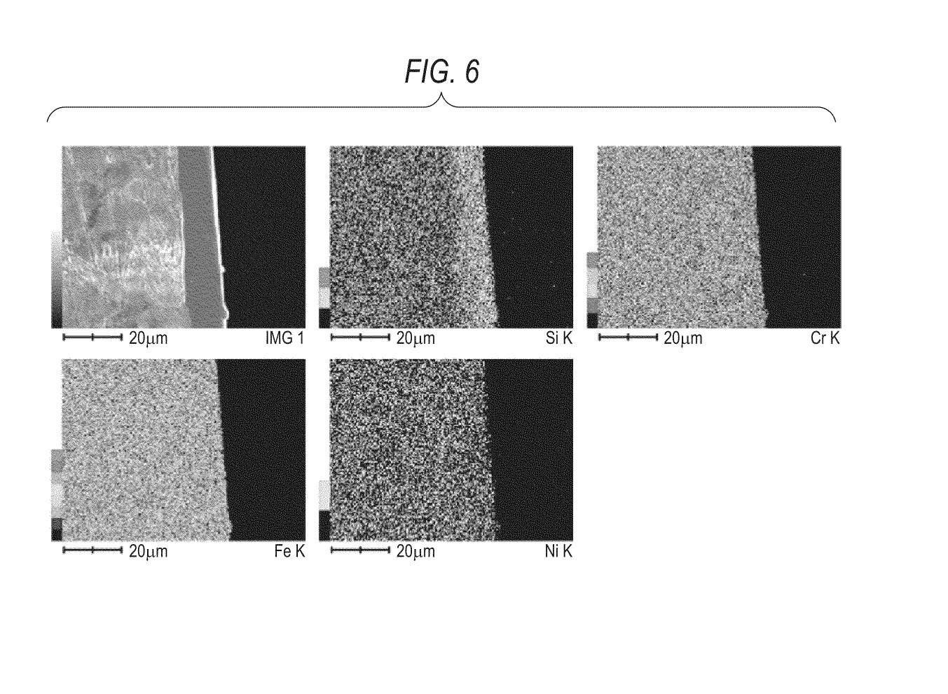

FIG. 6 is an analysis result of a surface layer containing Si.

It can be seen that the Si layer is not a single layer of only Si formed on the surface of a work piece but a mixed layer of Si and the work piece in which material of the work piece and Si are mixed on the surface of the work piece.

In FIG. 6, an upper left photograph is an SEM photograph of the cross section of an Si surface layer, an upper middle photograph is a surface analysis result of Si, an upper right photograph is a surface analysis result of Cr, a lower left photograph is a surface analysis result of Fe, and a lower right (middle) photograph is a surface analysis result of Ni.

As can be seen from the above, in the Si surface layer, Si is not placed on a base material but is formed as a portion with an increased Si concentration in a surface portion of the base material.

From this result, it can be seen that although the Si surface layer is a surface layer with a certain thickness, it is a surface layer in a state where Si permeates the base material with high concentration since the Si is united with the base material. This surface layer is an iron-based metal structure with an increased Si content. Accordingly, since an expression “film” is not appropriate, it will be called an Si surface layer below for the sake of simplicity.

Since this is in such a state, the surface layer is not peeled off unlike in other surface treatment methods. As a result of examination regarding this surface layer, high corrosion resistance was confirmed. In addition, it was found that the erosion resistance was very high when some conditions were satisfied. The erosion is a phenomenon where a member erodes by water or the like and is also a phenomenon leading to failures of a piping component along which water or steam passes, a moving blade of a steam turbine, and the like.

Here, how to evaluate the corrosion resistance and the erosion resistance, which will be discussed later in this specification, will be described.

Corrosion Resistance

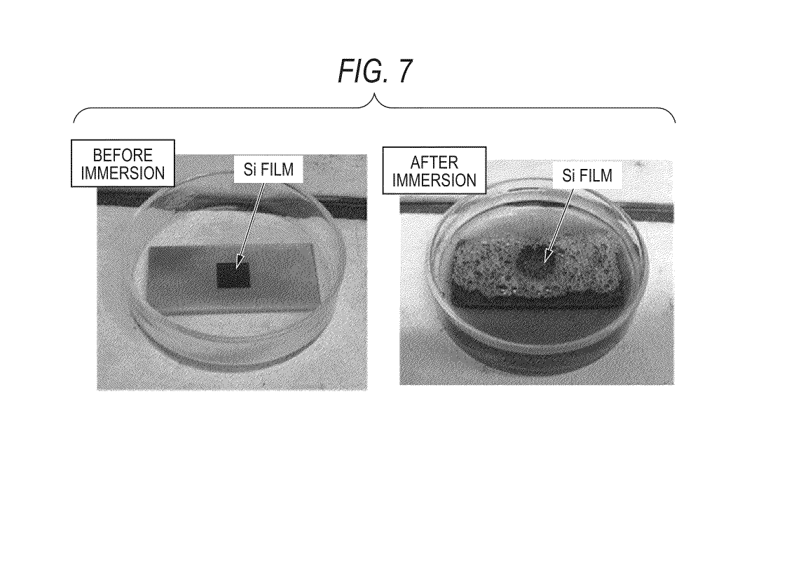

Regarding the corrosion resistance, a method of immersing a test piece formed with a film in aqua regia and observing the state of corrosion was adopted. An example of an experimental state is shown in FIG. 7. An Si surface layer was formed in a part of a test piece and was immersed in aqua regia to observe the state of corrosion of a surface layer portion and the state of corrosion of portions other than the surface layer. In FIG. 7, an (10 mm×10 mm) Si surface layer is formed in the middle of the test piece. In the corrosion test using aqua regia in this specification, it was immersed in aqua regia for 60 minutes and the surface was observed. In addition, a salt spray test of spraying salt water to a test piece in order to observe the generation of rust, a salt water immersion test of immersing a test piece in salt water in order to observe the generation of rust, and the like were performed in order to determine the corrosion resistance. However, details thereof are omitted in this specification.

Evaluation Test of Erosion Resistance

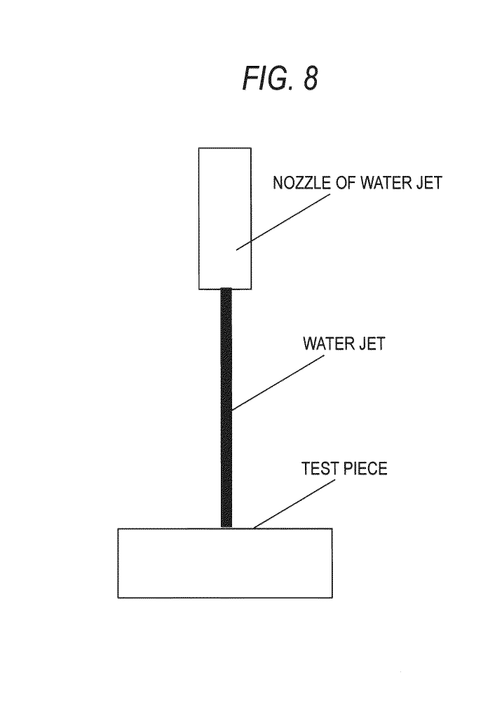

As evaluation regarding erosion resistance, a test of comparing the state of erosion by striking the test piece with a water jet was performed as shown in FIG. 8. Here, an experimental result showing the high erosion resistance of an Si surface layer which satisfies predetermined conditions will be described first. The predetermined conditions will be described later.

Regarding the erosion resistance of the present embodiment, a test result will be described below. As evaluation of erosion resistance, the state of erosion was compared by striking the test piece with the water jet.

The water jet was sprayed at the pressure of 200 MPa. As test pieces, four kinds of test pieces of 1) stainless steel base material, 2) Stellite (generally, a material used for erosion resistance), 3) a test piece obtained by forming a TiC film on the stainless steel base material surface by electrical discharge, and 4) a test piece obtained by forming a surface layer with a large amount of Si on the stainless steel by the present invention were used.

The film of 3) is a TiC film formed by the method disclosed in WO 01/005545, and is a film with high hardness.

A water jet was sprayed on each test piece for 10 seconds, and the erosion of the test piece was measured by a laser microscope.

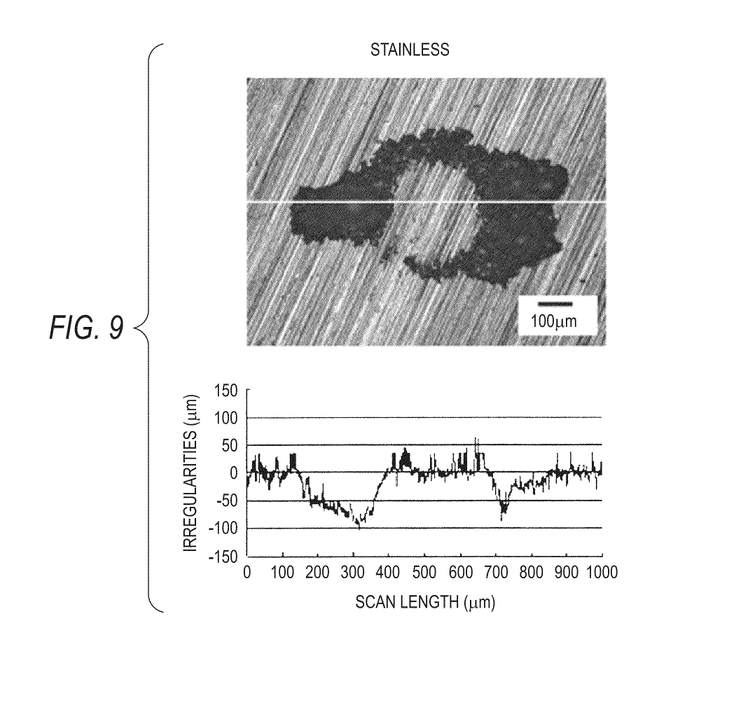

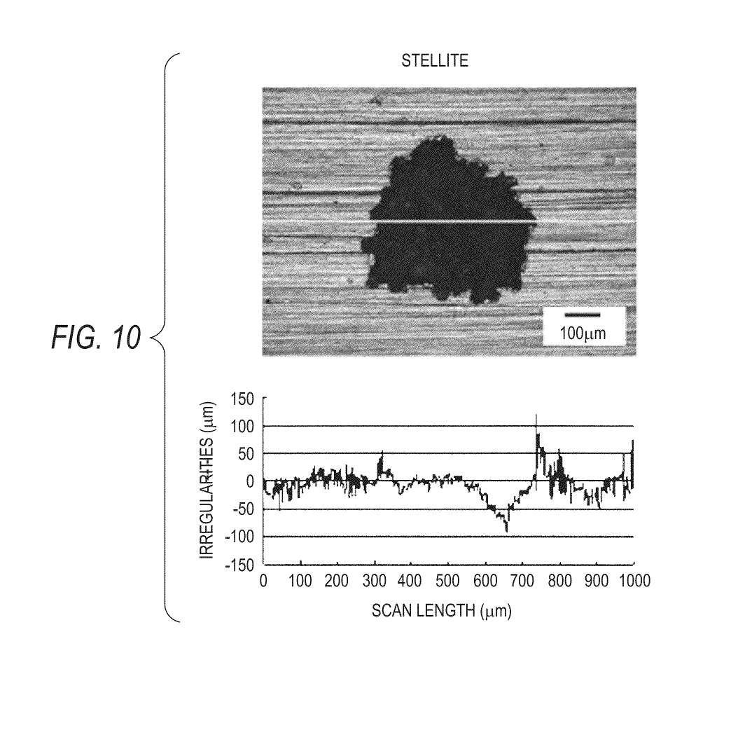

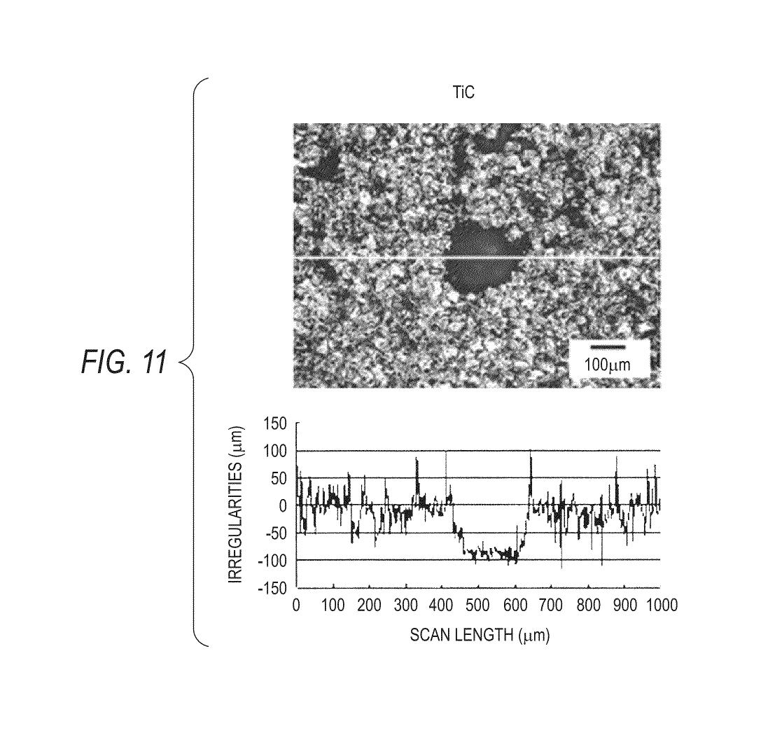

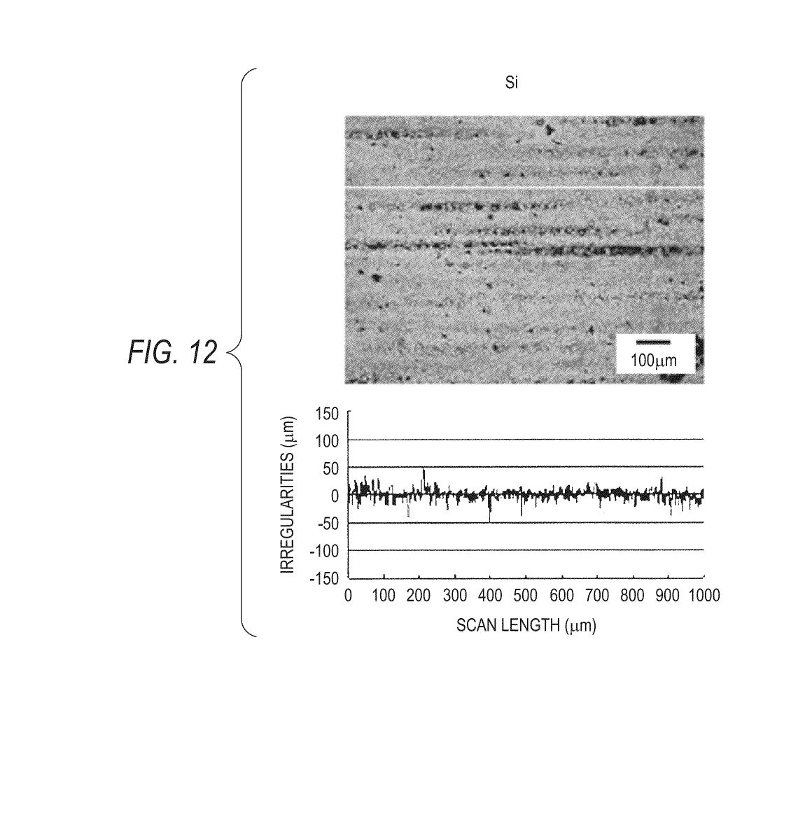

FIG. 9 is a result of 1), FIG. 10 is a result of 2), FIG. 11 is a result of 3), and FIG. 12 is a result of 4), that is, in the case of a surface layer according to the present embodiment.

As shown in FIG. 9, the stainless steel base material eroded up to the depth of about 100 μm when it was hit by the water jet for 10 seconds.

On the other hand, as shown in FIG. 10, in the Stellite material, the state of erosion was different, but the depth was about 60 to 70 μm. Accordingly, it was confirmed that the Stellite material had an anti-erosion property to some extent.

FIG. 11 is a result of a TiC film with very high hardness, but it eroded up to the depth of 100 μm. This result shows that the erosion resistance is not proportional to the surface hardness.

On the other hand, FIG. 12 is a result in the case of a surface layer of Si according to the present embodiment, and it can be seen that it hardly corroded. The hardness of this surface layer was about 800 HV (since the thickness of the surface layer was small, it was measured with a load of 10 g using a micro hardness tester; the hardness range was a range of about 600 to 1100 HV). This hardness is higher than the stainless steel base material (about 350 HV) shown in 1) or the Stellite material (about 420 HV) shown in 2) but lower than the TiC (about 1500 HV) shown in 3).

That is, it can be seen that the anti-erosion property is a complex effect including not only the hardness but also other characteristics.

In FIG. 11, hollowing is apparent in spite of a hard film. Accordingly, it is presumed that when only the surface is hard, it is broken by the impact of the water jet in the case of a thin film which is not a tough surface.

On the other hand, the film of 4) in the present embodiment is tough in addition to having the crystal structure of the surface layer, which will be described later. Therefore, it becomes a surface capable of withstanding the deformation, and this point is presumed to be a cause showing the high erosion resistance.

The surface layer of 4) is tested with a thickness of about 5 μm. However, in the case of a thin film, it was additionally confirmed that the strength was not enough either and erosion easily occurred.

Presumably, one of the main reasons why the erosion resistance was not found in Patent Citation 1, which was the related art, even though a film of Si was examined and high corrosion resistance was clear, is that the surface layer could not be made thick.

In the case of erosion resistance, it is preferable to have a surface layer of 5 μm or more even though it depends on the speed at which a material as a cause of erosion, such as water, collides. It is needless to say that a desirable thickness changes with a collision material. For example, in the case of a high speed or a large droplet, it is preferable that the surface layer is thick.

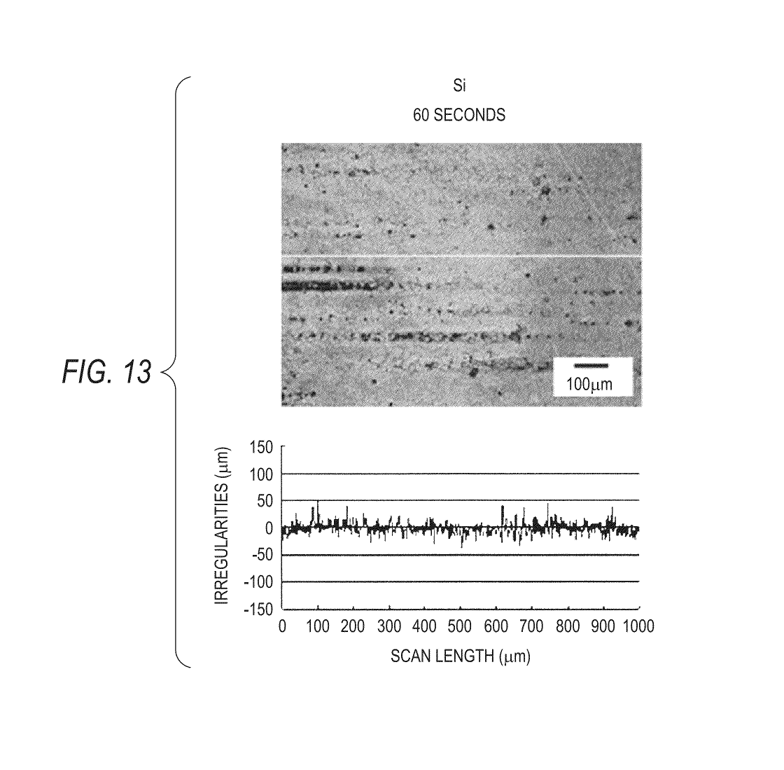

Since it was difficult to confirm any erosion in the test of the surface layer of Si shown in 4), a result obtained by extending the test regarding the surface layer of Si such that the surface layer was hit by the water jet continuously for 60 seconds is shown in FIG. 13.

The location hit by the water jet is slightly polished and is distinguishable, but it can be seen that it is hardly worn.

As described above, high erosion resistance of the surface layer of the present embodiment was confirmed.

It was found that there were two important elements in order to acquire the anti-erosion property and the anti-corrosion property described above. One of them is film forming conditions, and the other one is a time for which a film is formed, more accurately, the progress of processing. Each will be described in detail below.

First, the film forming conditions which are the first element will be discussed.

The influence of film forming conditions will be described from the evaluation result of erosion resistance using the water jet.

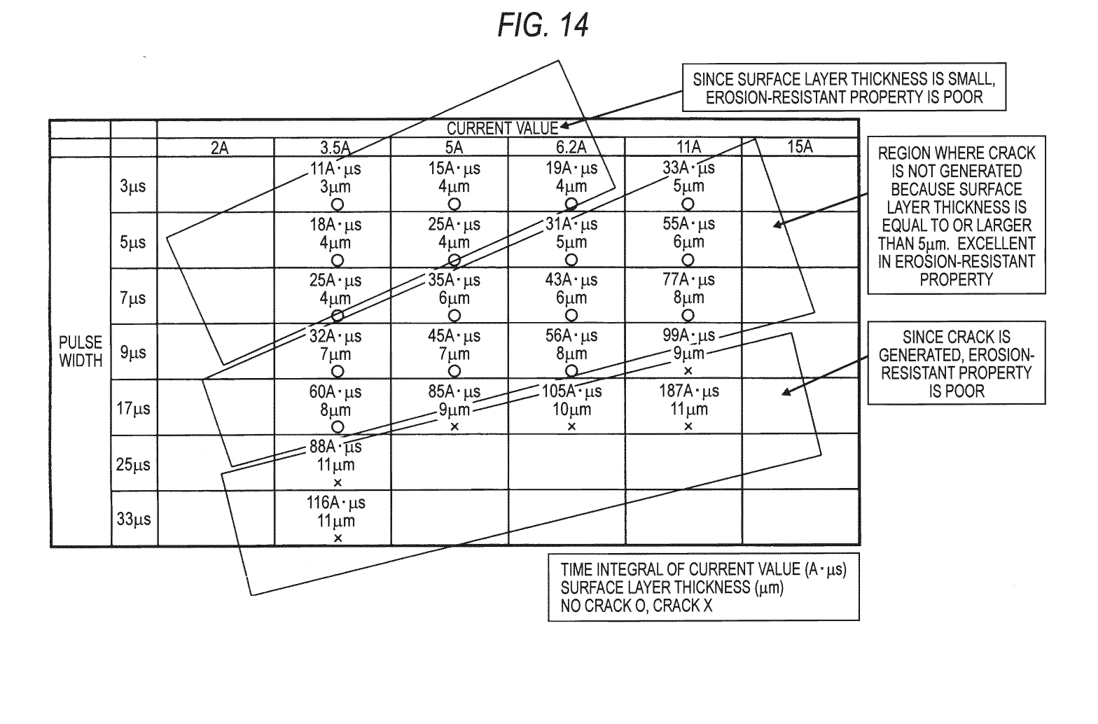

The state of erosion was examined by striking a film with a water jet under each of the conditions shown in FIG. 14.

FIG. 14 shows, for each processing condition, the value (A·μs) of a time integral of a current value of an electrical discharge pulse which is a value equivalent to energy of an electrical discharge pulse in the condition (in the case of a rectangular wave, current value ie×pulse width te), the thickness of the Si surface layer in the processing condition, and the existence of a crack of the Si surface layer.

As the processing conditions, the horizontal axis indicated the current value ie and the vertical axis indicated the current pulse te, and a current pulse of a rectangular wave with the value was used. A base material used for this test was SUS630.

Si with ρ=0.01 Ωcm was used, an electrode with a size in a range where an electrical discharge pulse was normally generated was formed to perform the test. As can be seen from the drawing, the film forming conditions, that is, energy of an electrical discharge pulse is closely related to the thickness of a film (film thickness), and it can be said that energy of an electrical discharge pulse is almost proportional to the film thickness.

From the drawing, the existence of a crack can be seen as one of the formation conditions of the Si surface layer. The existence of a crack is strongly correlated with energy of an electrical discharge pulse. It can be seen that “when the time integral value of an electrical discharge current which is an amount equivalent to energy of an electrical discharge pulse is in a range equal to or smaller than 80 A·μs” is the conditions for forming an Si surface layer without a crack.

Undoubtedly, whether or not a crack is generated according to the processing conditions is also influenced slightly by a base material.

For example, among materials called stainless steel, there is a tendency that the generation of a crack is relatively difficult in a material which is a solid solution, such as SUS304, and a crack is generated slightly more easily in a precipitation hardening material, such as SUS630. Since precipitation hardening stainless steel, such as SUS630, is generally used for a steam turbine, a desirable range where a crack is not generated is slightly narrower than austenitic stainless steel, such as SUS304.

It has been described that since the thickness of the Si surface layer is correlated with the time integral value of an electrical discharge current which is an amount equivalent to the energy of an electrical discharge pulse, the thickness decreases as the time integral value of an electrical discharge current decreases and the thickness increases as the time integral value of an electrical discharge current increases. The thickness referred to herein is a thickness in a range where melting occurs with energy of electrical discharge and into which Si, which is an electrode component, is injected.

Although the range of heat influence is decided by the time integral value of an electrical discharge current which is an amount equivalent to the amount of energy of an electrical discharge pulse, the amount of injected Si is also affected by the number of times of occurrence of electrical discharge. When the amount of electrical discharge is small, the amount of Si injected is undoubtedly not sufficient. Accordingly, the amount of Si of the Si surface layer is decreased. On the contrary, even if electrical discharge occurs sufficiently, the amount of Si of the Si surface layer is saturated at a certain value. This point will be described in detail later when discussing a film formation time which is the second element.

Although the explanation comes later, the performance of the Si surface layer will be discussed below.

In addition, there are two modes in erosion. One is a mode in which the surface is largely removed by the impact of water, and the other one is a mode in which a surface is scratched and scraped off when water flows on the surface while strongly striking the surface.

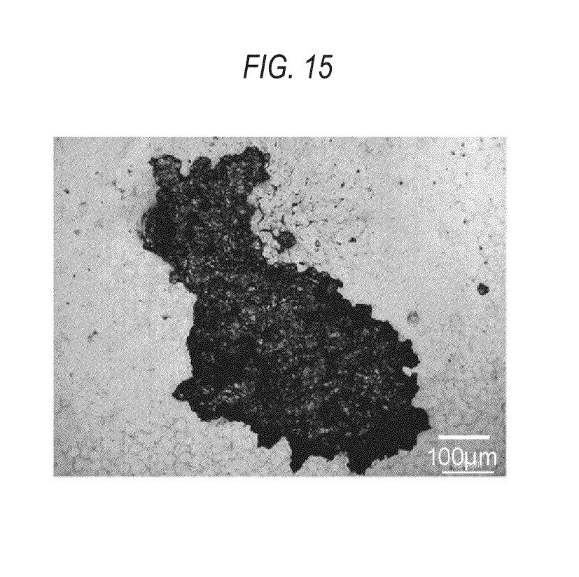

FIG. 15 is a result in which an Si surface layer with a thickness of 3 μm was damaged when striking the surface layer with a water jet of 200 MPa for 60 seconds. Although a mark stripped off finely is not visible, it can be seen that it is largely broken. Presumably, this is not damage stripped off by collision of water but is resultant damage due to the Si surface layer not withstanding the impact of a large quantity of water in the water jet. That is, this shows that when the Si surface layer is as thin as 4 μm or less, it is effective to some extent for a mode in which water scratches and scrapes off the surface when flowing on the surface while striking the surface strongly but is less effective for a mode in which the surface is largely removed by the impact of water.

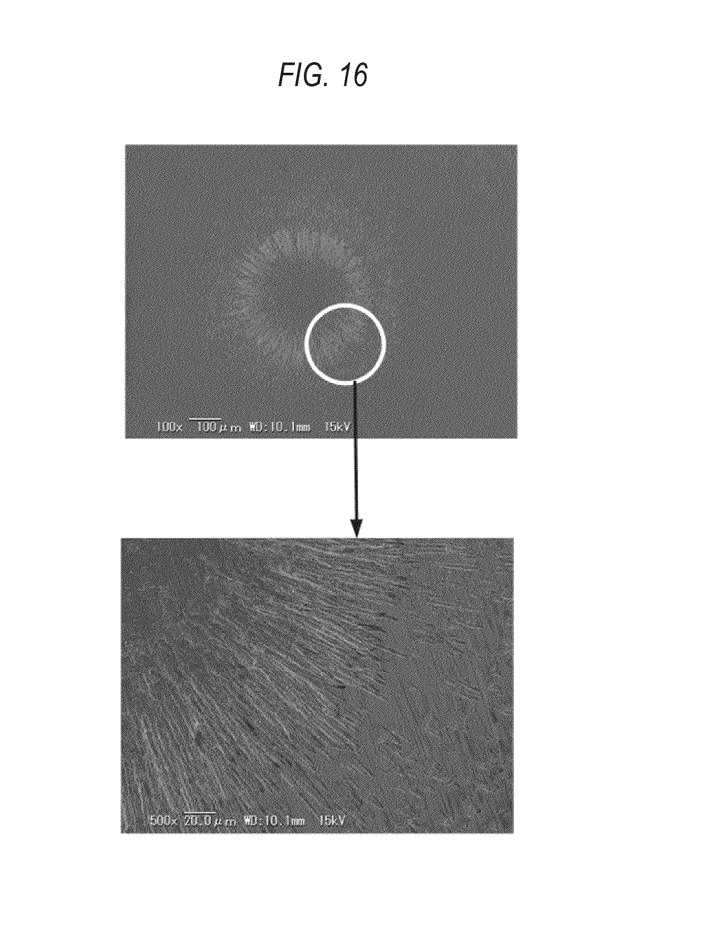

In addition, FIG. 16 is a result when Stellite No 6, which is a material with high erosion resistance, is used and is hit by a water jet of 90 MPa for 60 seconds. In the drawing, the mode in which water scratches and scrapes off the surface when flowing on the surface while striking the surface strongly is shown.

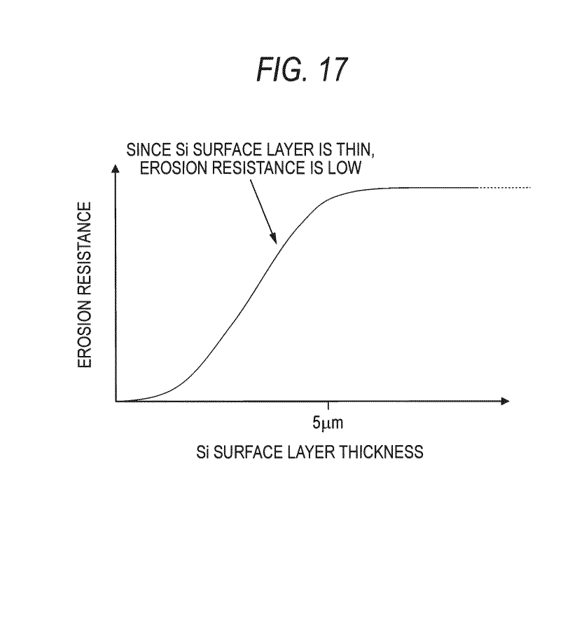

Next, the relationship between the thickness of the Si surface layer and the erosion resistance is shown in FIG. 17.

As shown in the drawing, it was found that when the thickness of the Si surface layer was equal to or smaller than 4 μm, if the water jet was sprayed at the speed of about sound speed which was equivalent to a speed at which water droplets collide with a turbine blade in a steam turbine, a film could not withstand this if the Si surface layer was thin and accordingly, a probability that a phenomenon of surface breakage would occur was high.

The reason why the film is weak against impact if the Si surface layer is thin and strong against impact if the Si surface layer is thick is presumed to be as follows. That is, if the Si surface layer is thin, distortion is gradually accumulated in a base material when impact occurs and finally, breakage occurs from the grain boundary of the base material. However, if the Si surface layer is thick, the base material is protected because it is difficult for distortion to reach the base material. In addition, since the Si surface layer is an amorphous structure, there is no grain boundary. Therefore, breakage in a grain boundary does not occur.

From this point of view, in order to make the Si surface layer thick, it is necessary to increase the energy of an electrical discharge pulse. It was found that energy of an electrical discharge pulse needed to be equal to or larger than 30 A·μs in order to make the Si surface layer have a thickness of 5 μm or more.

Although the erosion resistance can be raised by increasing the film thickness of the Si surface layer as described above, there is also a problem caused by increasing the film thickness, and this may worsen the erosion resistance. As described above, it is necessary to increase the energy of an electrical discharge pulse in order to make the Si surface layer thick. However, as the energy of an electrical discharge pulse increases, the influence of heat also increases to generate a crack on the surface. A probability for the generation of a crack increases as the energy of an electrical discharge pulse increases. When it is processed in a pulse of 80 A·μs or more as described above, a crack is generated on the surface.

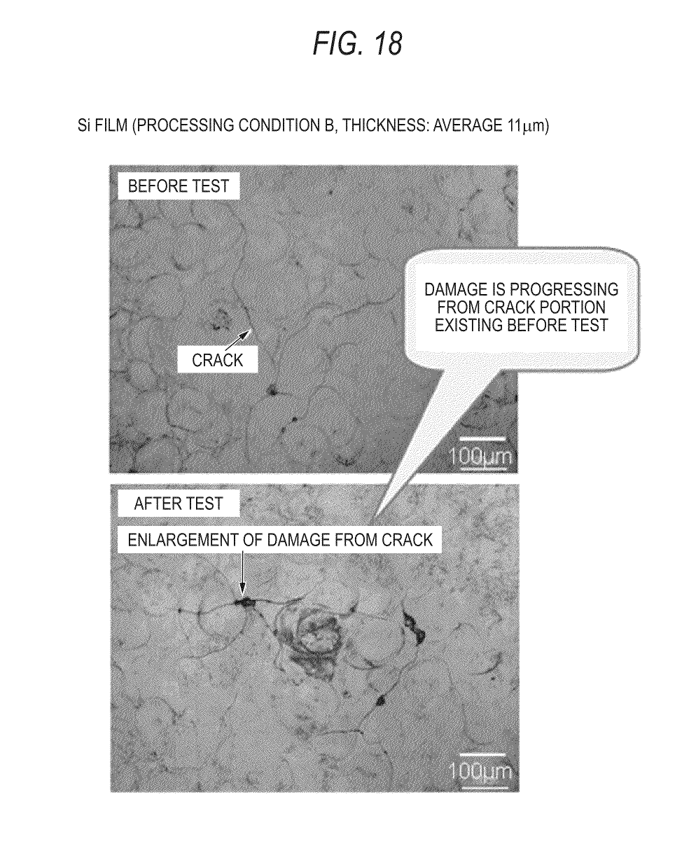

It was found that the anti-erosion property noticeably worsened when a crack was generated on the surface. FIG. 18 shows a state where cracking is progressing by striking the Si surface layer, which was processed under the electrical discharge pulse conditions of 80 A·μs or more, with the water jet. If the process continues further, the film is largely broken in a certain range. When the Si surface was processed under the electrical discharge pulse conditions of 80 A·μs, the film thickness became about 10 μm. Accordingly, it was found that this became a practical upper limit of the Si surface layer for application of erosion resistance.

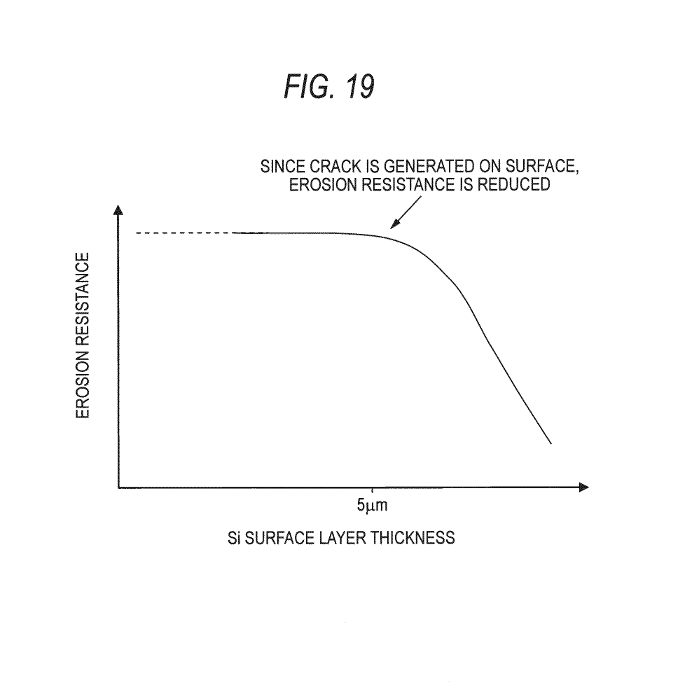

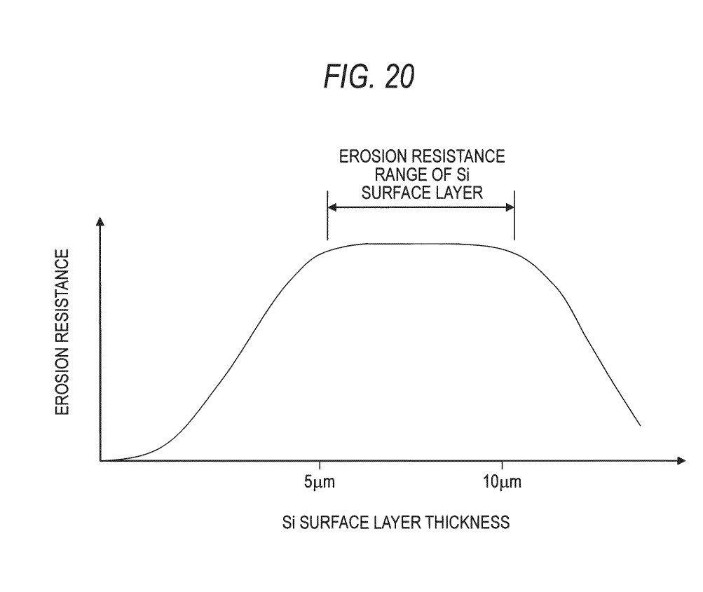

From the point of view of a crack, the relationship between the film thickness of the Si surface layer and the erosion resistance is shown in FIG. 19. It was found that if FIGS. 17 and 19 were combined, the relationship between the film thickness of the Si surface layer and the erosion resistance became like FIG. 20.

The above is summarized as follows. In order to form an Si surface layer with an anti-erosion property, the thickness of the Si surface layer needs to be equal to or larger than 5 μm. Accordingly, the energy of an electrical discharge pulse needs to be equal to or larger than 30 A·s.

On the other hand, in order to prevent a surface crack, the energy of electrical discharge pulse needs to be equal to or smaller than 80 A·μs. Accordingly, the thickness of the Si surface layer becomes equal to or smaller than 10 μm.

That is, the conditions for forming an Si surface layer with an anti-erosion property are a film with a thickness of 5 μm to 10 μm. For this, energy of an electrical discharge pulse is 30 A·μs to 80 A·μs. In this case, the film hardness is in the range of 600 HV to 1100 HV.

While the film forming conditions have been described from the point of view of erosion, it was found that there was almost the same tendency for the corrosion resistance. It has been reported that high corrosion resistance is obtained when an Si surface layer is formed on steel. However, it was found that this is largely influenced by film forming conditions and a raw material. Also in the case of corrosion resistance, it is very important that there is no crack on the surface when the energy of an electrical discharge pulse is equal to or smaller than 80 A·μs. On the surface where a crack has been generated, corrosion progresses from the crack. Accordingly, the anti-corrosion property for such a material cannot be expected.

In addition, on the contrary, it was found that when the energy of an electrical discharge pulse was small and a film was thin, the corrosion resistance was not acquired to a sufficiently practical extent in many cases. When considering the conditions required for the film thickness, it is also necessary to consider which material is to be used to form a film. Although the above-described test was performed using SUS630, there is a mold field as an important object to which the present invention is applied. The same corrosion resistance test was also performed for cold die steel SKD11 which is a main material used in the mold field, a carbon steel for mechanical structure S—C material which is a material used for parts, and the like.

SUS630 or SUS302 are materials with little precipitate or materials with a relatively small amount of precipitate even if it exists. On the other hand, for materials with a large amount of precipitate like SKD11 or S50C, a defect occurs in a surface layer when the surface layer is thin. Since a precipitate is in the surface layer, it reduces the corrosion resistance of the surface layer or becomes an origin of erosion. In addition, when electrical discharge occurs, a precipitate is a cause of a defect generated in the surface layer because a base material and the ease of occurrence of electrical discharge or a state where a material is removed when electrical discharge occurs is different.

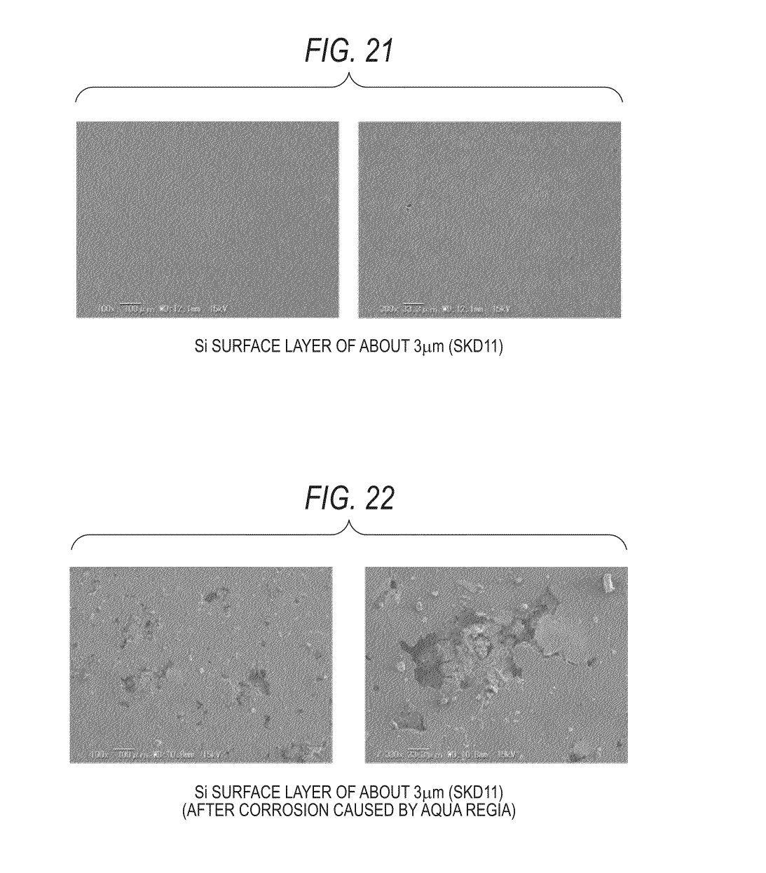

FIG. 21 shows a state where an Si surface layer of about 3 μm is formed on the surface of cold die steel SKD11, which is frequently used in the mold field or the like, under the conditions close to the conditions in the related art. FIG. 22 shows a photograph of a state where an Si surface layer of about 3 μm is formed on the surface of cold die steel SKD11 under the conditions close to the conditions in the related art and then corroded in aqua regia. In a material used generally frequently, it was found that sufficient corrosion resistance was not acquired in the Si surface layer of about 3 μm. The processing time at this time is an optimal processing time, which will be described later. In addition, when forming the surface layer of about 3 μm, conditions equivalent to the conditions in the related art by the power supply method of the present invention are used instead of the power supply circuit method of the method in the related art shown in FIG. 3.

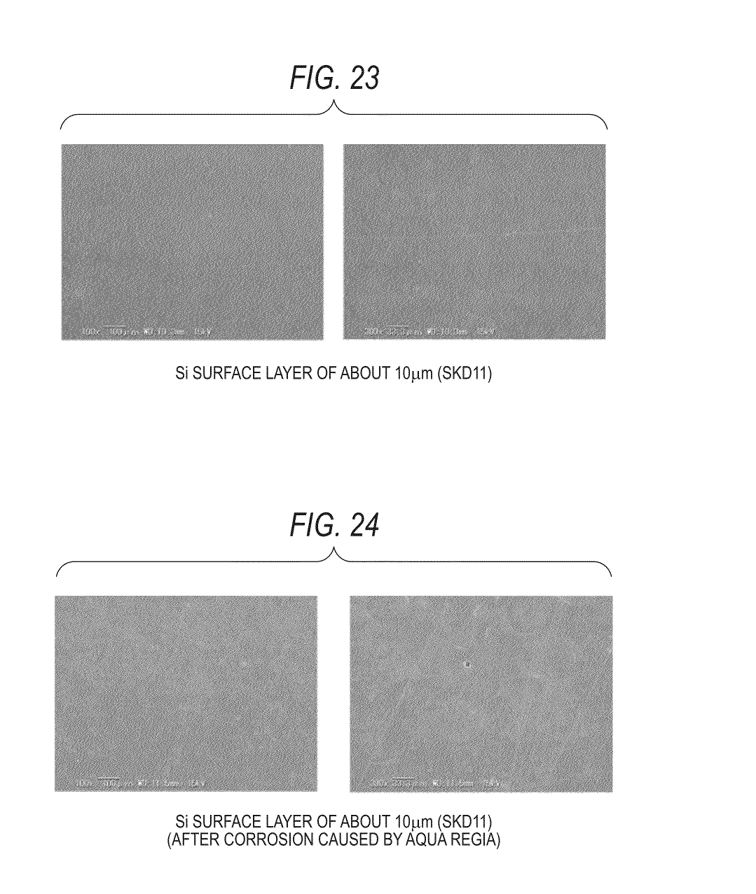

On the other hand, FIG. 23 is a surface photograph when an Si surface layer of about 10 μm was similarly formed in various materials. It can be seen that in the surface layer forming conditions of about 5 μm to 10 μm, there is no defect of the surface which was a problem in the case of a surface layer of 2 μm and accordingly, the surface layer is formed uniformly. Although FIG. 24 is a photograph after corrosion in aqua regia, it can be confirmed that there was no damage on the surface and the corrosion resistance was high. In order to acquire such corrosion resistance, it was preferable to form an Si surface layer of about 5 μm or more.

Next, since there is a problem in a surface layer with a thickness of 3 μm, the reason why a surface layer with a thickness of about 5 μm to 10 μm has an anti-corrosion property will be considered.

Generally, there is a non-uniform structure, such as a precipitate, inside steel. It is equal to or larger than about several micrometers in many cases. For this reason, even if an Si surface layer is formed on the material surface, the influence of a precipitate may remain on the surface.

Particularly under the conditions where the energy of a pulse at the time of processing is small, it can be easily expected that the influence of a precipitate is large.

The limit up to which such an influence becomes significant is estimated to be about 5 μm. This does not necessarily mean that the size of a precipitate is 5 μm to 10 μm. Even if this is a material in which precipitate and carbide of 10 μm or more are present, uneven distribution of materials were scarcely found in a portion of a surface layer when it was processed under the conditions where a surface layer of about 5 μm to 10 μm was formed. Presumably, this is because a base material and Si supplied from an electrode are agitated while making electrical discharge repeatedly occur and accordingly, it becomes a uniform structure.

Thus, it was found that high corrosion resistance was acquired when the Si surface layer with a thickness exceeding 5 μm was formed. However, in order to acquire the high corrosion resistance, not only the processing conditions but also important conditions of an appropriate processing time, which will be described later, should be satisfied.

When these conditions were satisfied, the erosion resistance was confirmed similarly.

From various kinds of experiment, it was found that exhibiting the characteristics of the Si surface layer termed the corrosion resistance and the erosion resistance with general materials in such a wide range was difficult when the thickness of the surface layer was about 3 μm and that satisfactory characteristics were obtained when the thickness of the surface layer was about 5 μm or more.

The reason why the film thickness of about 10 μm or less is required as conditions for which the Si surface layer acquires an anti-erosion property and an anti-corrosion property is easily understood. If a crack is generated on the surface by the influence of heat, both the erosion resistance and the corrosion resistance may be reduced. However, it is not so easy to clearly explain the reason why the necessity of the thickness of 5 μm or more is the same in both the erosion resistance and the corrosion resistance. In the case of an application such as a steam turbine, the thickness of a surface layer may need to be equal to or larger than 5 μm in order to withstand the load of collision of water droplets. However, it may also be thought that making the inside composition of the surface layer uniform contributes to withstanding erosion as described above. Nevertheless, it is thought that the consistency of the structure of a surface layer requested for the seemingly different functions of corrosion resistance and erosion resistance has many implications.

Next, a time (more accurately, progress of processing) for which a film is formed, which is the other element, will be discussed. As described above, although the pulse conditions when forming the Si surface layer and the thickness of the Si surface layer, which is almost decided by the pulse conditions and which has a large effect on the characteristics of the Si surface layer, have been described, the performance is not necessarily decided by only the pulse conditions.

The following factors were found by analysis of the Si surface layer from which the corrosion resistance and the erosion resistance described above were obtained.

The amount of Si was 3 to 11 wt % when a sufficient amount of Si was included in the Si surface layer. It was 6 to 9 wt % in the Si surface layer by which a more stable performance was obtained. The amount of Si referred to herein is a value measured by an energy dispersive X-ray spectroscopic method (EDX), and the measuring conditions are an acceleration voltage of 15.0 kV and an irradiation current of 1.0 nA.

In addition, the amount of Si is a value of a portion indicating almost the maximum value in the surface layer. In order to obtain this performance, there should be an optimal processing time. This was examined as follows. In addition, although it was described as a processing time, it is actually important how much Si is supplied to a work piece from an electrode. For example, a processing time in the meaning of how much electrical discharge per unit area is made to occur is important. That is, the proper processing time is undoubtedly increased if a pause time of electrical discharge is set to be long, and the proper processing time is shortened if a pause time of electrical discharge is set to be short. This becomes almost equal to the idea regarding how much electrical discharge per unit area is made to occur. However, in this specification, the “processing time” is used unless specified otherwise for the simplicity of explanation.

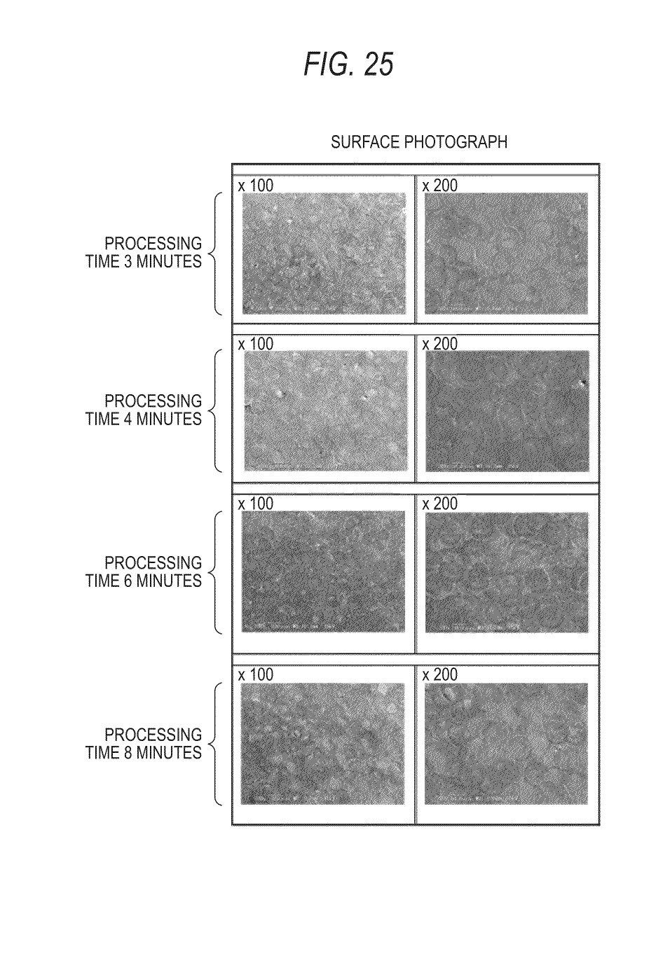

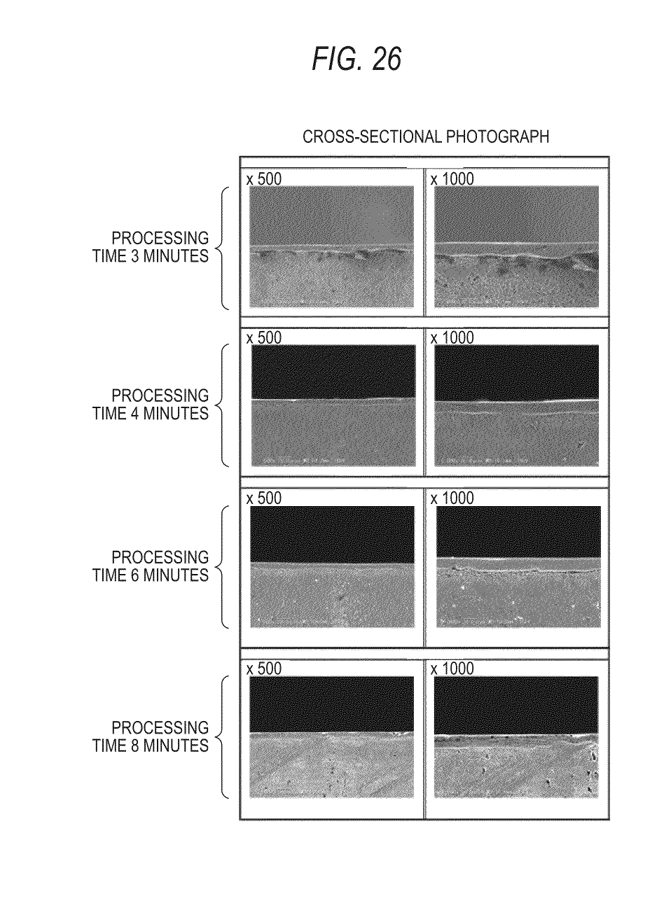

Although the point in which the amount of Si of the Si surface has an effect on the property of unevenness of the surface has been described, the example is shown in FIGS. 25 and 26.

Processing of an Si electrode under the same processing conditions is performed while changing these conditions every time, and the state of the surface of the Si surface layer was observed (FIG. 25) and the cross section of the Si surface layer was observed (FIG. 26).

Since all processings are performed under the same processing conditions, it may be thought that the ratio of processing time is almost the same as the ratio of the number of times of electrical discharge that occurs. That is, the number of times of electrical discharge is small when the processing time is short, and the number of times of electrical discharge is large when the processing time is long. (However, since a processing time changes according to the conditions, such as a pause time, a required processing time changes if the pause time changes in order to generate the same number of electrical discharge pulses.)

The processing time of the Si surface layer shown in the drawing is 3 minutes, 4 minutes, 6 minutes, and 8 minutes. The following things can be concluded from the drawing.

When the processing time is short (3 minutes), it is observed that the surface is still uneven in many places and there is a projection-shaped small portion on the surface. (Although not shown in the drawing, the shorter the processing time, the larger the number of projection-shaped portions. The processing time of 3 minutes is a boundary where a projection is not noticeable.)

It is known that if the processing time is increased, the number of these irregularities and projections is decreased and the surface becomes smooth accordingly.

On the other hand, the cross-sectional photograph shows that the thickness of the Si surface layer has remained almost unchanged with respect to the cross section from the processing time of 3 minutes to the processing time of 8 minutes. When the amount of Si of each film was analyzed, the amount of Si in a film corresponding to a processing time of 3 minutes was 3 wt %, the amount of Si in a film corresponding to a processing time of 4 minutes was 6 wt %, the amount of Si in a film corresponding to a processing time of 6 minutes was 8 wt %, and the amount of Si in a film corresponding to a processing time of 8 minutes was 6 wt %. When the processing time was short, a sufficient amount of Si was not injected into the surface layer. However, it was found that when a certain amount of processing time elapsed (in these condition, 4 minutes), the amount of Si became sufficient and the surface became smooth accordingly.

From the above, it can be seen that since the smoothness of a surface is not good if the amount of Si is small, 3 wt % or more is preferably required and more preferably, 6 wt % or more is required. (Although described in detail later, a test piece of 3 minutes corroded even though there was a slight effect of corrosion resistance as a result of having performed a corrosion test. There was no corrosion in the cases of 4 minutes, 6 minutes, and 8 minutes.)

As described above, it became clear that a timing at which the surface roughness was reduced and a timing at which the amount of Si of the surface layer became sufficient were equal. The reason is considered as follows.

Si is known as a material with a low viscosity when it melts. In the initial state of processing, Si is not sufficiently contained in the surface layer. Accordingly, the roughness of the surface caused by the occurrence of electrical discharge becomes dominant near the melt viscosity of steel which is a base material. When the processing proceeds and the Si concentration of the surface layer increases, the material easily flows when it melts. As a result, it is thought that the surface becomes smooth.

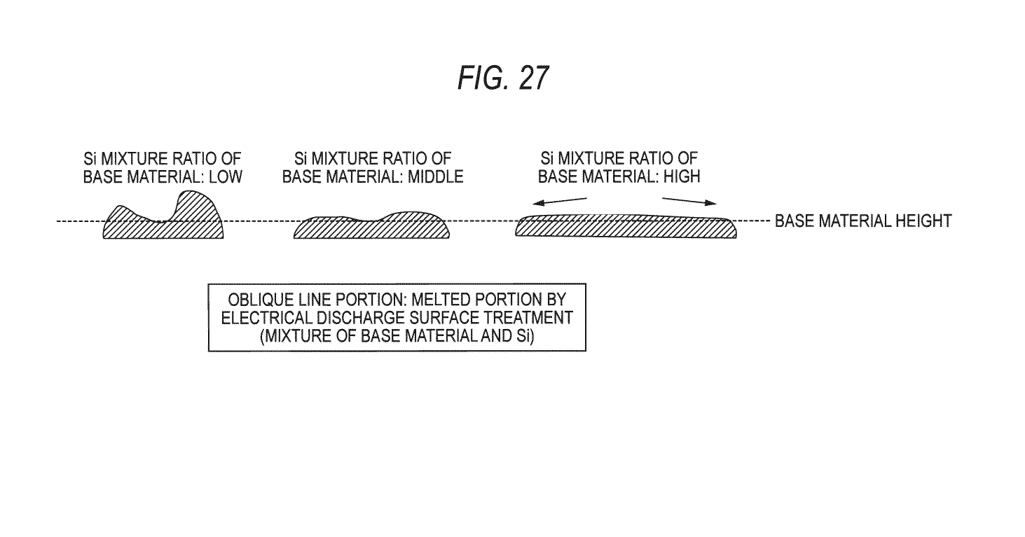

An explanation regarding this assumption is shown in FIG. 27.

Since it was found that the surface became smooth by injection of Si and the performance of the Si surface layer was exhibited, a clear indicator regarding how to decide a processing time was obtained.

Although the processing time was discussed from the point of view of the roughness of a surface, the relationship between the processing time, the surface roughness, and the film performance was confirmed in more detail. As the film performance, only the evaluation of corrosion resistance is shown herein.

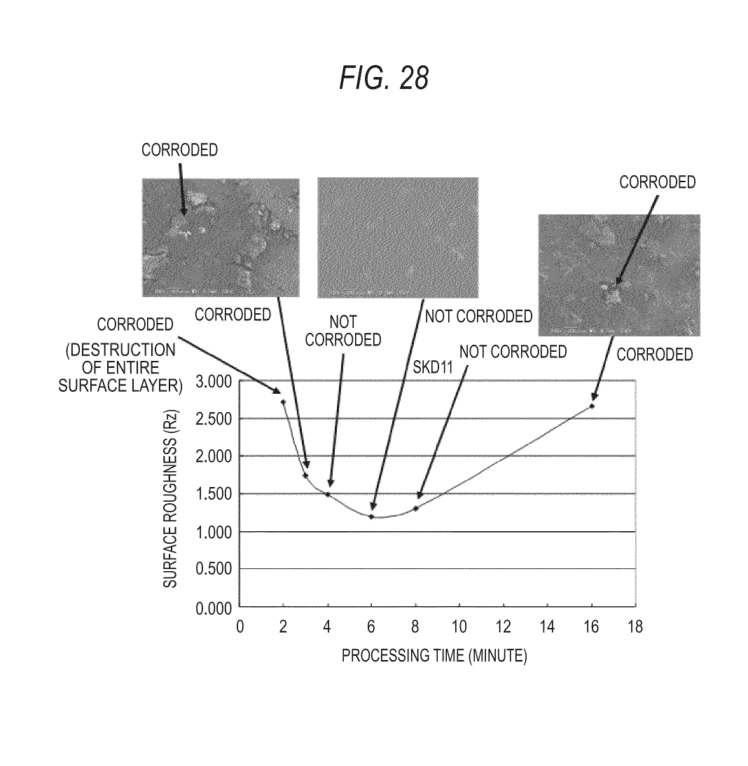

FIG. 28 is a graph showing the relationship between a processing time and the surface roughness (Rz) when changing the processing time of the cold die steel SKD11. Here, as the processing conditions, an Si electrode with an area of 10 mm×10 mm is used. For the area of 10 mm×10 mm, setting of a current value of a current pulse ie=8 A, a pulse width te=8 μs, and a pause time of electrical discharge to=64 μs is was adopted. That is, under the conditions where the energy of a pulse was about 60 A·μs, the processing time was 2 minutes, 3 minutes, 4 minutes, 6 minutes, 8 minutes, and 16 minutes.

Moreover, in the drawing, an electron microscope (SEM) photograph is shown after immersing a test piece in aqua regia and performing a corrosion test for each (part of) processing time.

In the case of a processing time of 2 minutes, the surface corroded and the surface layer could not be seen at all. In the case of a processing time of 3 minutes, the surface layer remained, but corrosion progressed to make the surface worn. Corrosion of a surface layer portion was not seen in the case of a processing time of 4 minutes, 6 minutes, and 8 minutes. In the case of a processing time of 16 minutes, corroded marks could be seen. The reason why the roughness becomes good as the processing time becomes long is as described above. In addition, the reason why the roughness becomes worse when the processing time becomes long is presumably that a work piece is removed by electrical discharge, which is continued for a long time, and as a result, a precipitate inside the work piece appears. However, there are also many reasons which are unknown.

As can be seen from FIG. 28, in these processing conditions, the surface roughness is reduced at the processing time of about 6 minutes (in this case, has a minimum value) and the corrosion resistance is high. The range where the corrosion resistance is high is at the processing time of about 4 minutes. The surface roughness at this time was about 1.5 times the surface roughness at the time of 6 minutes which is a minimum value.

In addition, although not shown, when the processing time was long, the corrosion resistance was sufficient until about 12 minutes, and the surface roughness at that time was also about 1.5 times the surface roughness at the time of 6 minutes.

Therefore, in order for the Si surface layer to exhibit the performance, it is necessary that it is in a range up to about 1.5 times the surface roughness when the surface roughness is reduced. If this is applied to the processing time, it is necessary that it is in a range of ½ to twice the processing time when the surface roughness is reduced.

This phenomenon also changes with a work piece material. In a material such as SUS304, a phenomenon is seldom seen in which the material becomes coarse after the surface roughness is once reduced. In addition, also when it becomes coarse, swelling appears as a whole by consumption of an electrode and removal of a work piece rather than appearance of a precipitate.

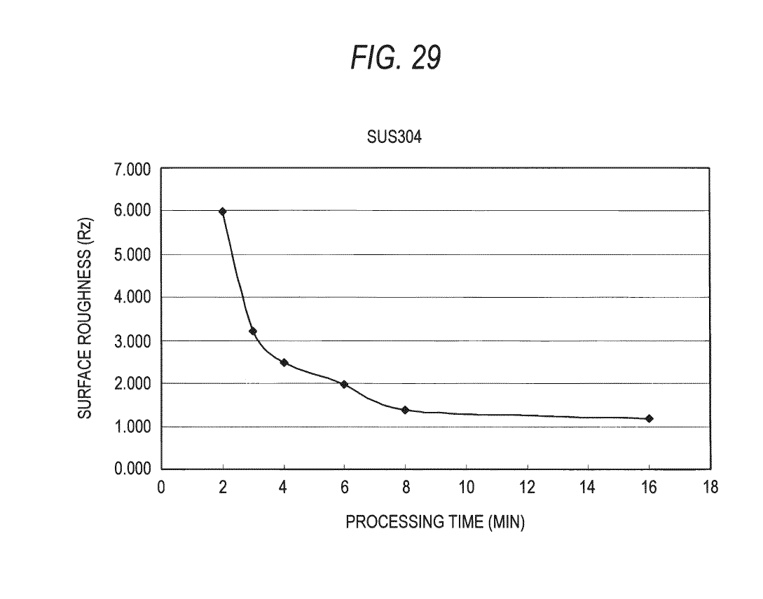

A graph in the case of SUS304 is shown in FIG. 29. The processing conditions are the same as those in the case of SKD11 of FIG. 28.

As can be seen from the drawing, in the case of SUS304, about 8 minutes during which the surface roughness has been reduced was an optimal processing (since a processing time was short, the film performance was obtained). Also at the time of about 6 minutes, appropriate corrosion resistance was acquired, and the surface roughness at that time was about 1.5 times the surface roughness at the time of 8 minutes. In the case of SUS304, even if a processing time became long, a phenomenon could not be seen in which the surface roughness increased rapidly like SKD11. In addition, a phenomenon did not appear either in which the corrosion resistance became worse rapidly even if the processing time became long. However, if the processing time became long, a recess of a processing portion, that is, a recess of a portion in which a surface layer was formed became large. For example, in the processing time of 12 minutes, the amount of recess became about 10 μm. This was an appropriate limit precision used as a mold.

Accordingly, even in the case of a material whose surface roughness does not become worse, a long processing time is not good, and it can be said that about twice the optimal value, at which the surface roughness is reduced, is an appropriate processing time.

As materials showing the transition of surface roughness shown in FIG. 28, there are S—C materials (S40C, S50C, and the like) and high-speed tool steel SKH51 in addition to SKD11.

In addition, as materials showing the transition shown in FIG. 29, there is SUS630 or the like.

In addition, although the processing time has been described in the above explanation, the processing time itself is not the essential element. Originally, it is important how many electrical discharge pulses are generated per unit area or how much energy is supplied. In addition, the processing conditions described in FIG. 28 are conditions in which electrical discharge occurs 5000 to 6000 times per second. In the case of 6 minutes as an appropriate processing time, electrical discharge occurs “5000 to 6000 times/second×60 seconds/minute×6 minutes”.

When the processing conditions are fixed, the ratio of the number of times of electrical discharge is the same as the ratio of processing time. However, when the processing conditions are changed during the process, management based on the processing time is meaningless. Even in this case, management based on the number of times of electrical discharge is effective.

As described above, it became clear that a timing at which the surface roughness was reduced was the same as a timing at which Si was appropriately injected into the work piece and also the same as a time at which the performance of a film was exhibited. A method of deciding a specific timing may be considered as follows.

1) In the case of immediately deciding a processing end timing while actually performing the processing, the surface roughness of a treatment surface is periodically measured and the processing is made to proceed in order while checking a decrease in the surface roughness. Even if it is measured, the processing is ended at a point of time when the surface roughness is not reduced.

2) In the case of performing processing after deciding a processing time in advance, an electrode as a reference is prepared, the relationship between the processing time and the surface roughness is checked as shown in FIGS. 28 and 29, and a time at which the surface roughness is reduced is set as an appropriate processing time in a reference processing area. When a reference electrode and the reference processing area are different in the case of actual machining, a processing time obtained by converting the area is calculated (in the same processing conditions, a time proportional to the area is set; when changing a period of electrical discharge by changing the processing conditions, a processing time is decided such that the number of times of electrical discharge per unit area becomes approximately equal), and the processing is performed for the processing time. Undoubtedly, such arrangement is not performed every machining, and it is preferable to acquire the data in advance so that it can be immediately used at the time of actual processing.

3) The processing time is not decided in advance, but what amount of electrode is consumed in the case of an appropriate processing time is checked beforehand from the data acquired in 2). At the time of actual processing, the processing is continued until an electrode reaches the amount of consumption.

Until now, three methods of deciding a processing time have been roughly described. However, various variations may be considered when this combination or the area changes. It has already been described that low surface roughness is a suitable state for a surface layer. However, if the processing proceeds, there is a place where the surface roughness is a minimum value. The surface roughness which is suitable for a film is only about 1.5 times the minimum value, and it is preferable that the processing time is in a range from half of the processing time at that time to about twice. If this range is exceeded largely, the concentration of Si is reduced or a precipitate appears on the surface. As a result, the corrosion resistance and the erosion resistance are reduced. In addition, when the processing time is long, a recess of a processing portion becomes large and this is not appropriate for practical use. In the case where those described above are processed in the same processing conditions, a desirable processing time range can be expressed as 1/2T0≦T≦2T0 assuming that a processing time at which the surface roughness is reduced is T0.

In addition, although this is a repetition of description until now, a desirable electrical discharge pulse width range is expressed as 1/2N0≦N≦2N0 assuming that a means for counting the number of electrical discharge pulses is provided and the number of electrical discharge pulses when the surface roughness is reduced (at the optimal processing time) is N0.

Since a processing time may change with a portion when performing processing on a part or a mold with a three-dimensional shape or the like, attention needs to be paid.

In addition, although the transition of surface roughness has been described so far, the surface roughness referred to herein is roughness as a surface formed by electrical discharge. That is, in connection with the surface roughness of an original base material, a good surface with surface roughness equal to or larger than a predetermined level is required. The above explanation was made at least on the assumption that the surface roughness of an original base material is smaller than irregularities which can be generated by the occurrence of electrical discharge.

That is, the discussed content is that when electrical discharge occurs, irregularities caused by the electrical discharge are formed on the surface. However, as an appropriate amount of Si is injected into the base material, the irregularities caused by electrical discharge are reduced.

In the case of a surface used in a normal mold or a high-precision part, these conditions are applied. Accordingly, a phenomenon in which the surface roughness is increased and then decreased appears as described so far. However, in the case where the surface roughness of an original base material is low, it is natural that there is no transition in which the surface roughness is increased and then decreased if it is viewed only from the value measured by total surface roughness. In this case, those described so far are undoubtedly similarly effective. However, predetermined correction is needed for a value described as surface roughness. This correction means that it is necessary to subtract the surface roughness of an original base material. In practice, it is to find a timing in advance, at which the surface roughness is increased in a fine base material (test piece for taking out the conditions) with another surface roughness and is then decreased, and to perform the processing for the corresponding processing time.

In the meantime, the reason why the Si surface layer of the present invention is excellent in erosion resistance performance is considered to be as follows. Generally, it is said that the erosion resistance is strongly correlated with the hardness. However, as also can be seen from the evaluation result described above, there are also many points which are difficult to explain only with the hardness. There are influences due to other surface properties other than hardness. It can be seen that a specular surface rather than a coarse surface increases the erosion resistance. The properties of the surface may also be mentioned as a reason why the erosion resistance is excellent in the Si surface layer. The Si surface layer is hard to some extent so as to have a hardness of 600 HV to 1100 HV. It is a smooth surface in regard to the properties of the surface. It is thought that this influences the erosion resistance.

In addition, a normal hard film (for example, the above-described TiC film or a hard film formed by PVD, CVD, and the like) is low in toughness. Accordingly, the film is broken by minimal deformation. However, the Si surface layer has characteristics in which a crack or the like is not easily generated, due to high toughness, even if a force for deformation is applied. This is thought to be one of the causes of high erosion resistance.

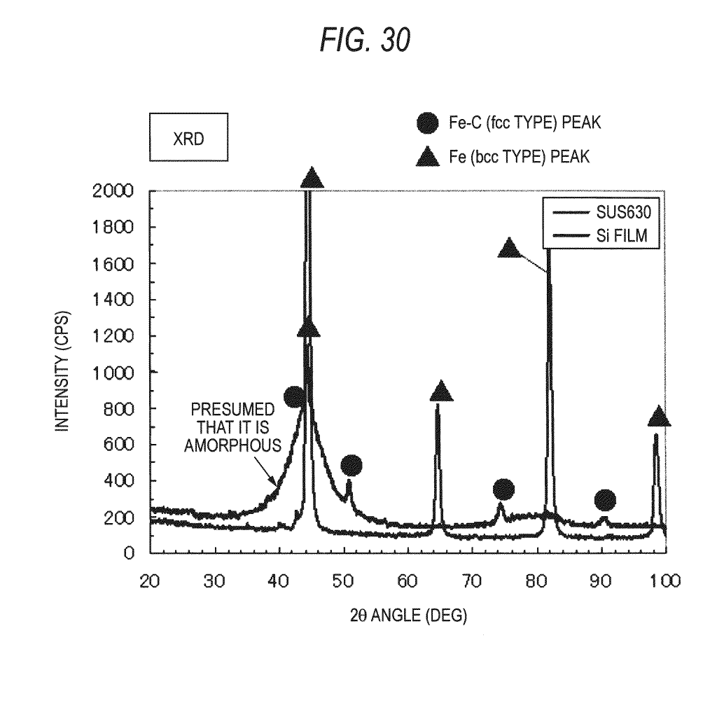

In addition, it is thought that the crystal structure of the Si surface layer also has an influence. An X-ray diffraction result of an Si surface layer formed in the conditions of the range of the present invention is shown in FIG. 30.

In this drawing, a diffraction image when an Si surface layer is formed on SUS630 as a base material is shown.

As can be seen from the diffraction image of the Si surface layer, a peak of the base material is seen, but a broad background where formation of an amorphous structure is recognized is observed. That is, the Si surface layer is amorphous. For this reason, it is thought that it is difficult for breakage to occur in the crystal boundary, which easily occurs in a normal material.

Meanwhile, the Si surface layer described in this specification is an Si-concentration layer containing 3 to 11 wt % of Si, which is different from the layer of 3 μm described in Patent Citation 1.

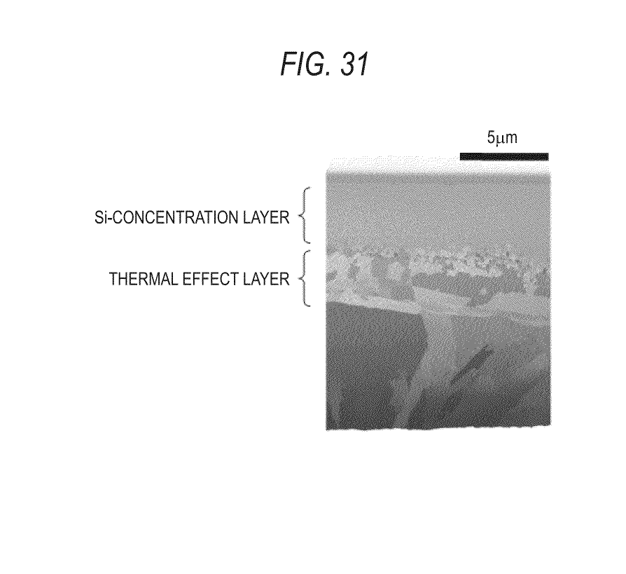

If the corresponding definition is explained in detail, since the thickness of a layer is specified by observation using an optical microscope regarding the layer described in Patent Citation 1, the thickness including the Si surface layer described in this specification and a thermal effect layer by electrical discharge surface treatment is defined as a layer of film thickness as shown in FIG. 31.

### Second Embodiment

Although the case where Si is used as an electrode has been described in the first embodiment, the same phenomenon can be applied to an electrode in which other materials are mixed with Si. In the case of a surface layer based on the Si electrode, characteristics, such as corrosion resistance and erosion resistance, are acquired. However, the hardness is about 800 HV, for example. Accordingly, this is not a hard material. For applications which require more hardness, it is also necessary to increase the hardness by mixing a hard material.

In the present embodiment, an explanation will be made using TiC powder as powder of a hard material.

An electrode for electrical discharge surface treatment was formed using TiC+Si mixed powder in which TiC powder and Si powder were mixed while gradually changing the ratio, and electrical discharge was made to occur by applying a voltage between the electrode and a processed material (base material) in order to form a surface layer on the base material.

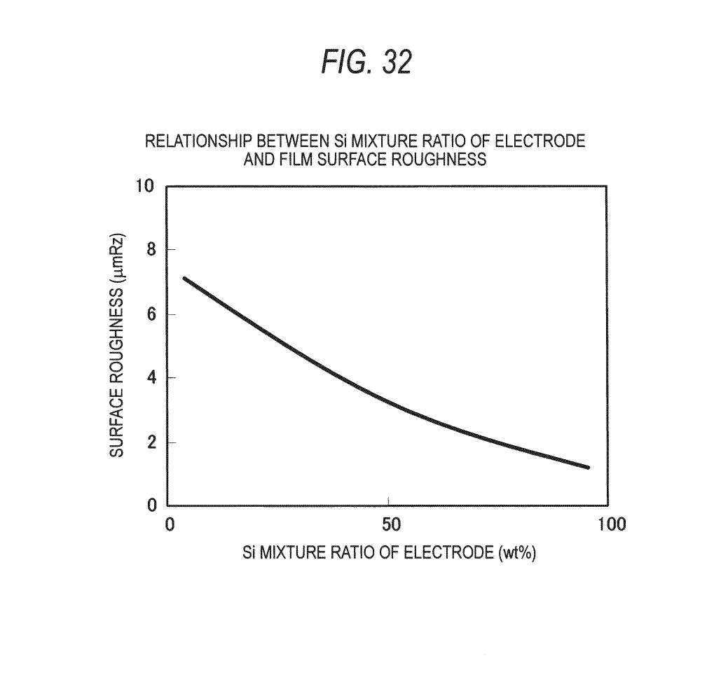

FIG. 32 shows the relationship between the Si mixture ratio (wt %) of an electrode and the surface roughness of a surface layer.

In the TiC+Si electrode formed by mixing Si powder with TiC powder while gradually changing the ratio, the surface roughness of a film processed on carbon steel for mechanical structure S45C was measured. As a result, as the Si mixture ratio of an electrode increased, the surface roughness of the surface layer decreased.

Moreover, in the present embodiment, the surface roughness of the surface layer changes in a range of 2 to 6 μm Rz.

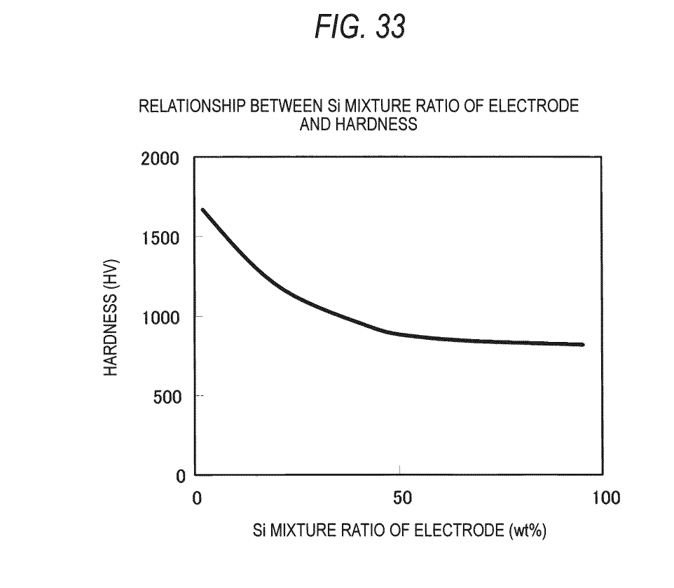

FIG. 33 shows the relationship between the Si mixture ratio (wt %) of an electrode and the hardness of a surface layer.

In the TiC+Si electrode formed by mixing Si powder with TiC powder while gradually changing the ratio, the hardness of the surface layer processed on the carbon steel for mechanical structure S45C was measured. As a result, when the Si mixture ratio was equal to or smaller than 60 wt %, the hardness of the surface layer decreased as the Si mixture ratio of an electrode increased.

In addition, when the Si mixture ratio is equal to or larger than 60 wt %, the hardness of the surface layer hardly changes. In addition, in the present embodiment, the hardness of the surface layer changes in a range of 800 to 1700 HV.

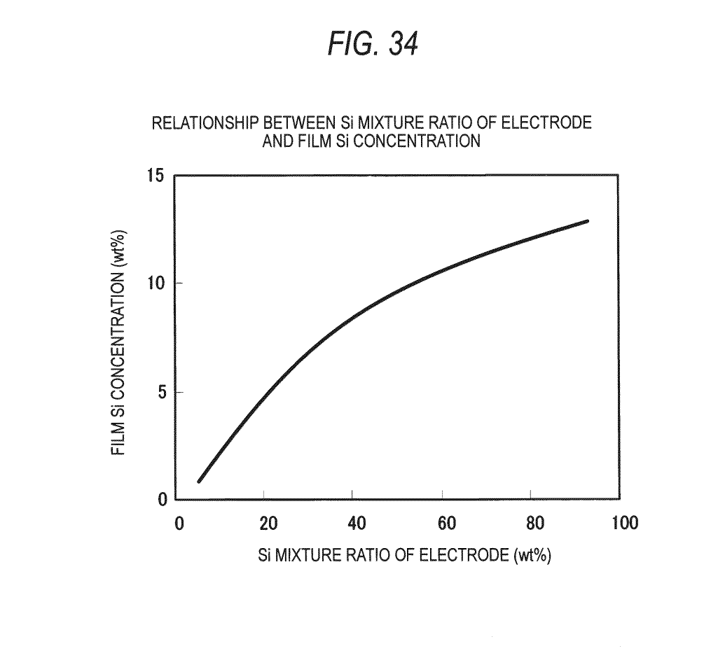

In addition, in the TiC+Si electrode formed by mixing TiC powder and Si powder while gradually changing the ratio, the Si concentration of the surface layer processed on the carbon steel for mechanical structure S45C was measured. The relationship between the Si ratio by weight within the electrode and the Si concentration of the surface layer is shown in FIG. 34.

As the Si ratio by weight within the electrode increases, the Si concentration of the surface layer also increases.

In addition, the amount of Si referred to herein is a value measured from the surface direction of the surface layer by an energy dispersive X-ray spectroscopic method (EDX), and the measuring conditions are an acceleration voltage of 15.0 kV and an irradiation current of 1.0 nA.

Thus, the Si concentration included in the surface layer increases as the Si mixture ratio of the electrode increases. As a result, it is thought that the surface roughness of the surface layer is reduced. In order to examine the mechanism, the surface of the surface layer was observed by the SEM.

As a result, it was observed that the number of defects, such as a crack, on the surface layer was reduced and embossment of each electrical discharge mark became small as the Si concentration increased.

Hereinafter, the electrode of each mixture ratio (ratio by weight) is written as a TiC+Si (8:2) electrode in the case of TiC powder:Si powder=8:2 and TiC+Si (5:5) electrode in the case of TiC powder:Si powder=5:5.

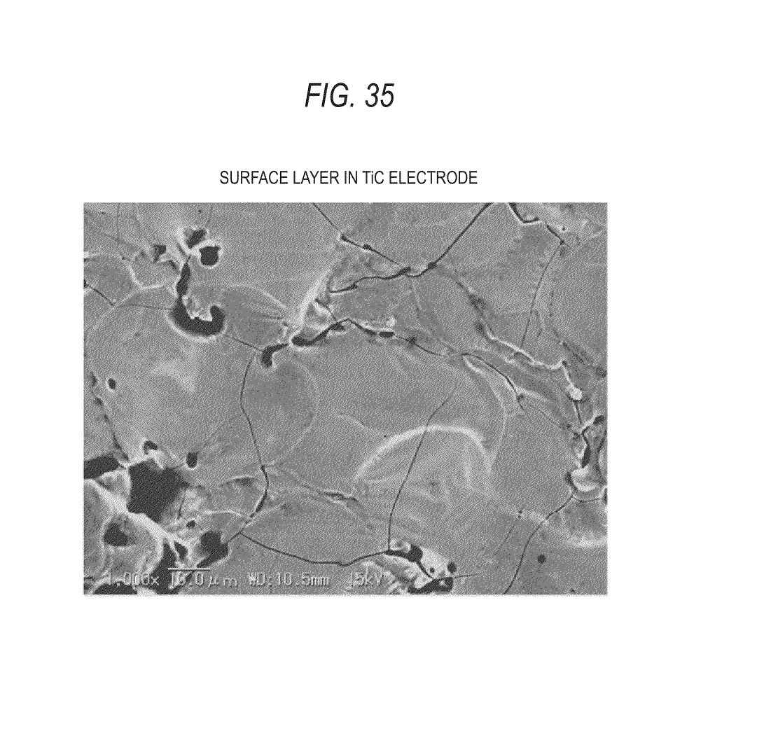

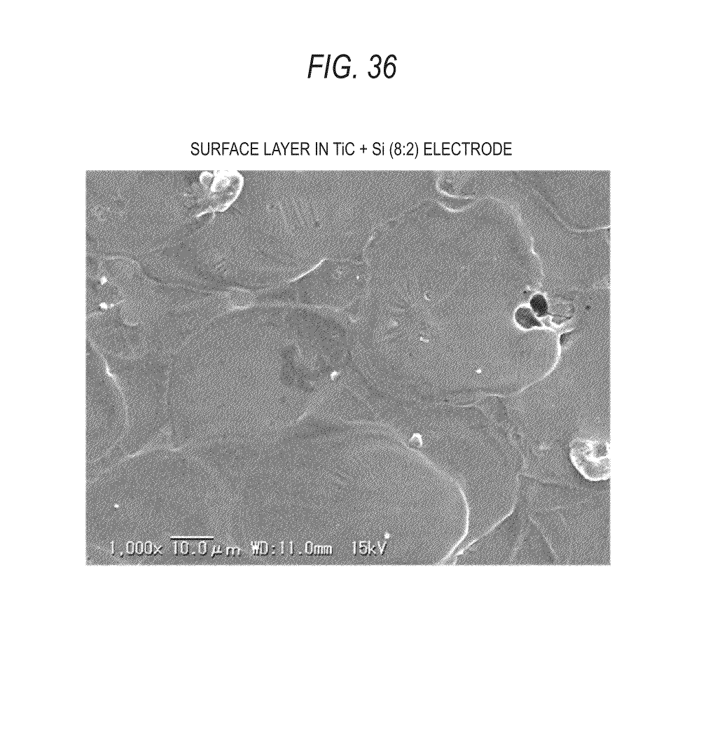

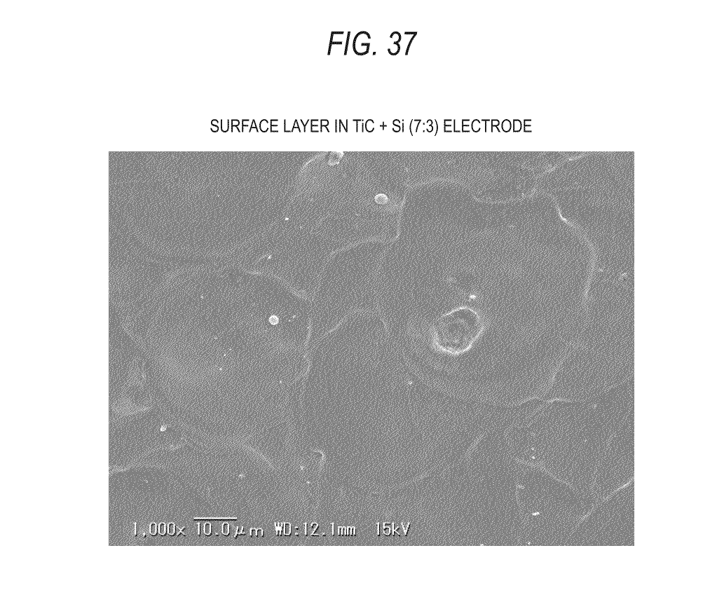

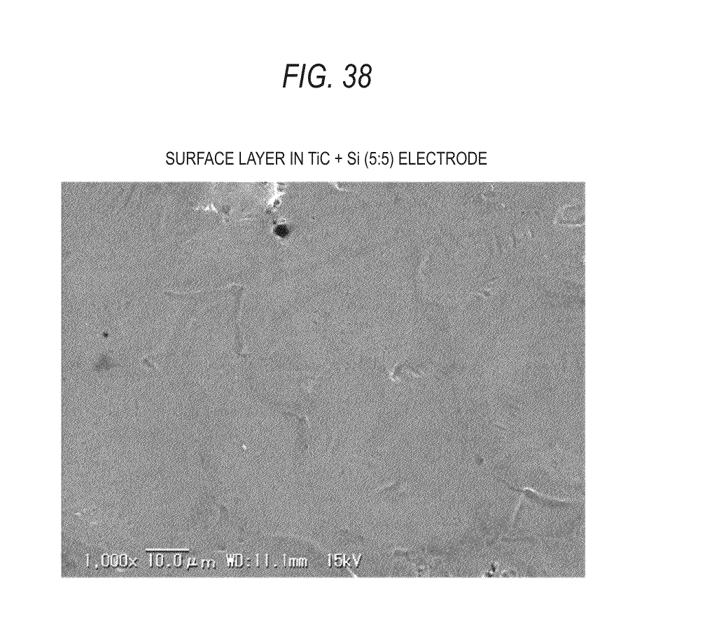

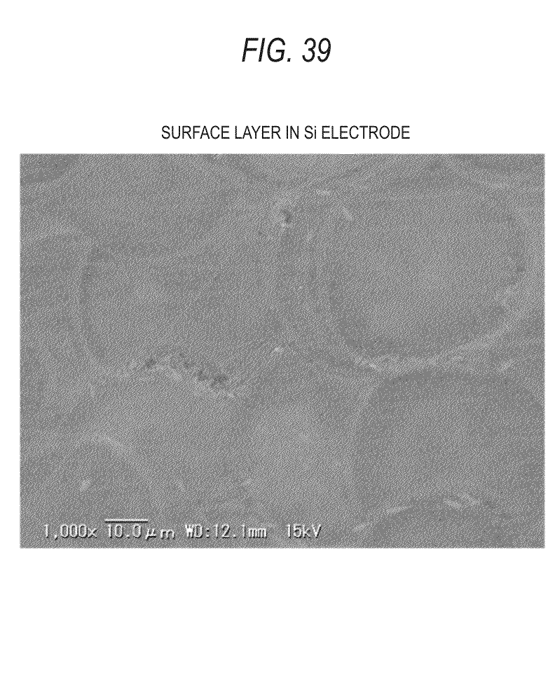

As an example, FIGS. 35 to 39 show SEM observation results of a surface processed in a TiC electrode as a comparison, surfaces processed in a TiC+Si (8:2) electrode, a TiC+Si (7:3) electrode, and a TiC+Si (5:5) electrode, and a surface processed in an Si electrode as a comparison.

On the treatment surface in the TiC electrode, there were so many defects, such as a crack, that swelling of each electrical discharge mark became large. In order of the TiC+Si (8:2) electrode, the TiC+Si (7:3) electrode, and the TiC+Si (5:5), the number of defects, such as a crack, on the surface layer decreased, and swelling of each electrical discharge mark became small. On the treatment surface in the Si electrode, it can be observed that a defect, such as a crack, was not found at all and swelling of each electrical discharge mark was so small.

Here, the mechanism in which swelling of each electrical discharge mark becomes small as the Si concentration included in the surface layer increases is considered as follows.

That is, since the viscosity of Si is smaller than those of other metals (0.94 mN·s/m²), when an electrode material melted by electrical discharge moves to a base material by mixing of Si and is solidified, the Si concentration of the melted portion is increased. Accordingly, since the coefficient of viscosity of the melted portion becomes small and there is solidification during further spreading and flattening, it is thought that the swelling becomes small.

As explained in FIG. 27, it is thought that TiC also flows easily when Si melts and accordingly, a smooth surface is formed.

X-ray diffraction measurement was performed on the surface layer processed in the TiC+Si electrode formed by mixing TiC powder and Si powder while gradually changing the ratio. As a result, a diffraction peak of TiC was confirmed, and it was found that TiC at the time of an electrode material existed on the surface layer as TiC even after electrical discharge surface treatment. In addition, a diffraction peak of a Ti single substance was not confirmed.

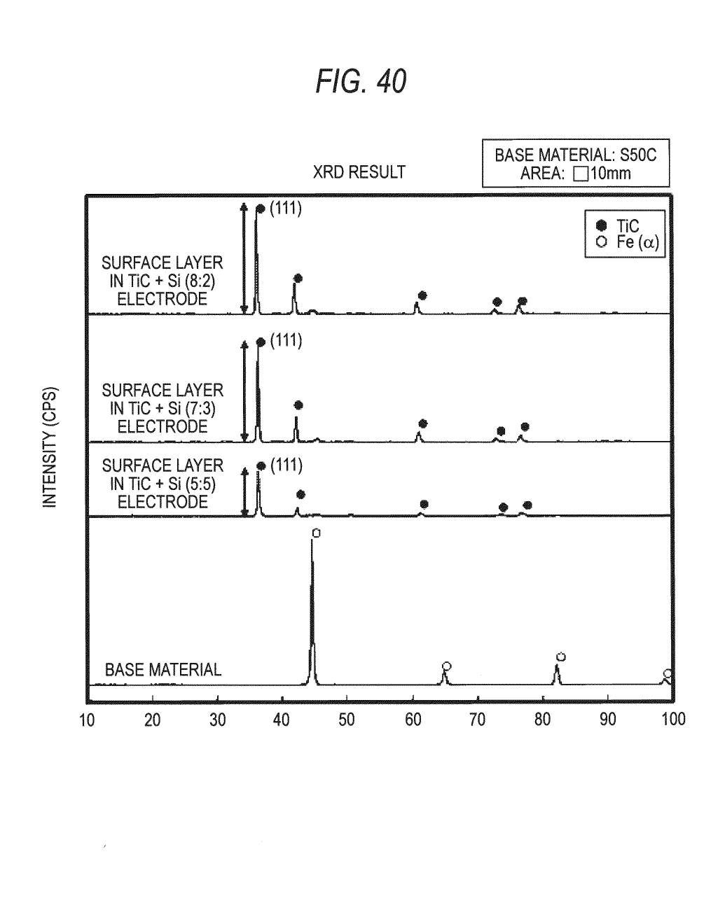

As an example, a result of XRD diffraction measurement of films formed in the TiC+Si (8:2) electrode, the TiC+Si (7:3) electrode, and the TiC+Si (5:5) electrode is shown in FIG. 40.

On the other hand, as the Si mixture ratio of an electrode increases, that is, as the TiC mixture ratio of an electrode decreases, the integral strength of a diffraction peak of TiC of the surface layer also decreases.

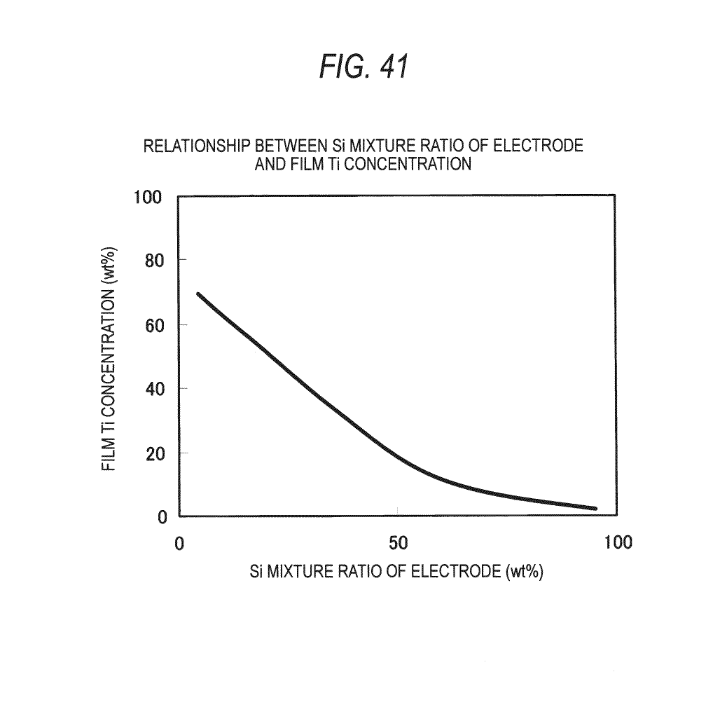

In addition, FIG. 41 shows the relationship between the Si mixture ratio of an electrode and the Ti concentration of a film.

As the Si mixture ratio of an electrode increases, that is, as the TiC mixture ratio of an electrode decreases, the Ti concentration of the surface layer also decreases. From the result of XRD diffraction measurement, it is thought that TiC at the time of an electrode may be partially decomposed at the time of electrical discharge surface treatment but most TiC exists in the surface layer as it is in the state of TiC because the peak of a Ti single substance is not found.

From the above, it is presumed that as the Si mixture ratio of an electrode increases, that is, as the TiC mixture ratio of an electrode decreases, the TiC concentration of the surface layer is also decreased relatively.

From the above, it is thought that the concentration of hard TiC is decreased on the surface layer as the Si mixture ratio of an electrode increases and as a result, the surface layer hardness is reduced.

On the other hand, although about several percent to several tens of percent by weight of Si element are present on the treatment surface as in the above-described quantitative analysis, the diffraction peak of Si crystal of Si could not be confirmed in any surface layer as a result of X-ray diffraction measurement. From this, it is thought that an Si single substance forms a base material component and an alloy or has an amorphous state.

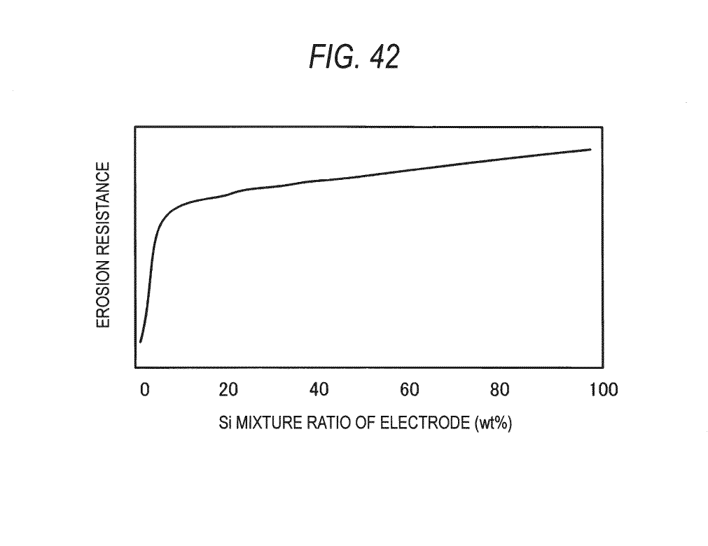

An effect of increasing the Si concentration of a film by mixing Si in an electrode is summarized as shown in FIG. 42.

That is, when the Si mixture ratio of an electrode is small, there are many defects, such as a crack, in a melted portion (film) by electrical discharge surface treatment and swelling of each electrical discharge mark is large.

On the other hand, as the Si mixture ratio of an electrode increases, the number of defects, such as a crack, is reduced, and swelling of each electrical discharge mark becomes small.

In addition, it is presumed that the Si single substance and the base material component in the film form alloy or the film has an amorphous state, and it is presumed that it has a film form in which TiC is distributed therein.

In addition, a part of the film is diffused up to the position lower than the base material height. The surface layer is about 5 to 10 μm including the diffused portion.

Next, evaluation of each film regarding the erosion resistance was performed for a surface layer processed in the TiC+Si electrode formed by mixing TiC powder and Si powder while gradually changing the ratio.

Here, SUS630 (H1075) was used as a base material.

In addition, the erosion resistance was evaluated by striking the surface layer with a water jet.

In addition, although it is generally said that the erosion resistance is strongly correlated with hardness, there are also many points which cannot be explained only with the hardness as described above. As elements other than the hardness, properties of the surface influence it. It can be seen that a smooth surface rather than a coarse surface increases the erosion resistance.

Although it was already found that high erosion resistance was obtained in the surface layer processed in the Si electrode, an improvement in the erosion resistance began to appear in the surface layer processed in an electrode formed by mixing 5 wt % or more of Si in the TiC electrode as a result of this evaluation.

In addition, with 5 wt % or more of Si, variations were observed in evaluation since defects were slightly present on the surface. Therefore, if the mixture ratio was further increased, a sufficient effect was acquired with 10 wt % or more. More preferably, mixing of 20 wt % or more of Si is good. In the case of mixing of 20 wt % or more, there was no variation in evaluation and high erosion resistance was acquired.

In addition, it is thought that having the high erosion resistance as described above is because the following points work complexly.
Since the surface layer is amorphous, it is difficult for breakage in the crystal boundary to occur
Since TiC is distributed, it has high hardness
Since Si is mixed, it becomes smooth

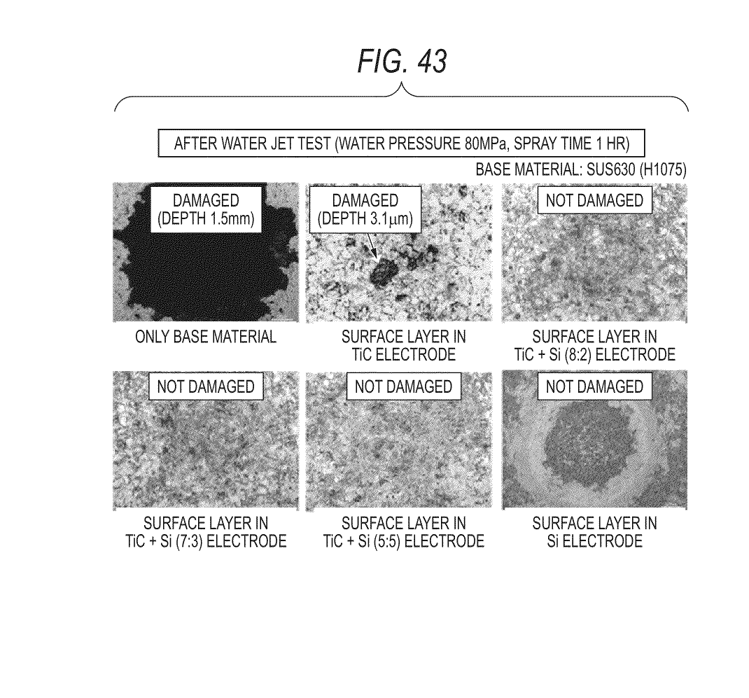

As an example, a result of observation of the surface state after spraying a water jet of 80 MPa onto the surface layer processed in the TiC+Si (8:2) electrode, the TiC+Si (7:3) electrode, and the TiC+Si (5:5) electrode for 1 hour is shown in FIG. 43.

As a comparison, a result in only a base material, a surface layer in the TiC electrode, and a surface layer in the Si electrode are also shown in the drawing. Large breakage occurred only with the base material. Also in the treatment surface in the TiC electrode, breakage occurred. On the other hand, breakage did not occur in any film processed in the TiC+Si (8:2) electrode, the TiC+Si (7:3) electrode, and the TiC+Si (5:5) electrode.

Next, evaluation of each surface layer was performed for corrosion resistance. Here, SUS316 was used as a base material. Although it is known that high corrosion resistance is obtained in the surface layer processed in the Si electrode, the surface layer processed in an electrode formed by mixing 5 wt % or more of Si in the TiC electrode showed high corrosion resistance.

In addition, with 5 wt % or more of Si, variations were observed in evaluation since defects were slightly present on the surface. Therefore, if the mixture ratio was further increased, a sufficient effect was acquired with 10 wt % or more. More preferably, mixing of 10 wt % or more of Si is good. In the case of mixing of 20 wt % or more, there was no variation in evaluation and high corrosion resistance was acquired.

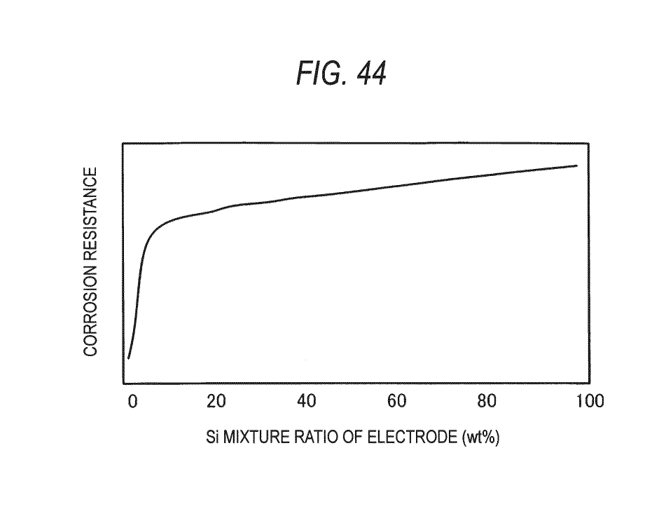

FIG. 44 is a view schematically showing the relationship between the Si mixture ratio of an electrode and the corrosion resistance.

In addition, it is thought that having the high erosion resistance as described above is because the following points work complexly.
Since the surface layer is amorphous, it is difficult for corrosion from the crystal boundary to occur
Since Si is mixed, the number of defects, such as a crack, is small

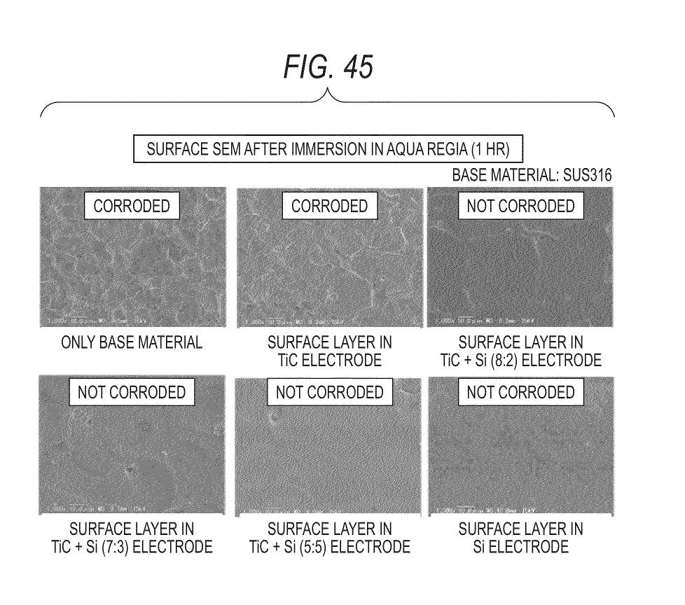

As an example, a result of observation of the surface state after immersing the surface layer processed in the TiC+Si (8:2) electrode, the TiC+Si (7:3) electrode, and the TiC+Si (5:5) electrode in etchant: aqua regia for 1 hour is shown in FIG. 45.

As a comparison, a result in only a base material, a surface layer in the TiC electrode, and a surface layer in the Si electrode are also shown in the drawing. There is a large amount of corrosion with only the base material. Also in the treatment surface in the TiC electrode, there is corrosion. On the other hand, corrosion does not occur in any film processed in the TiC+Si (8:2) electrode, the TiC+Si (7:3) electrode, and the TiC+Si (5:5) electrode.

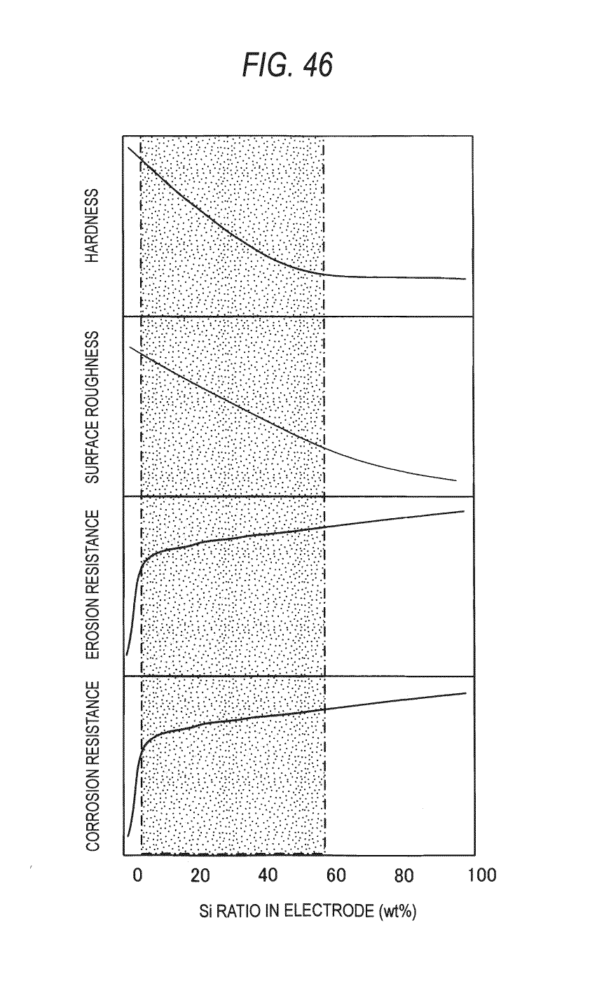

From the results obtained previously, FIG. 46 is obtained assuming that the horizontal axis indicates the Si mixture ratio (ratio by weight) in an electrode for electrical discharge surface treatment and the vertical axis indicates film characteristics (surface roughness, hardness, erosion resistance, corrosion resistance) obtained by processing in the electrode.

That is, when the Si mixture ratio is 5 to 60 wt %, the film is smooth and is high in hardness, and it is also possible to form a surface layer with high erosion resistance and corrosion resistance. If the stability and the like are taken into consideration, it is preferable that the Si mixture ratio is 20 wt % or more. However, the smaller the amount of Si, the higher the hardness.

When the Si mixture ratio is 5 wt % or less, the surface roughness is almost the same as that of the surface layer in the TiC electrode, and sufficient erosion resistance and corrosion resistance are not acquired.

Taking the corrosion resistance and the erosion resistance into consideration, the Si weight ratio of 20 wt % or more is an appropriate condition.

In the present embodiment, the case where Si is mixed with TiC has been described. However, since good characteristics are obtained for the above-described reasons, other hard materials may be used instead of TiC. For example, W, Mo, and the like may be used if it is a metal, and carbide, such as WC, VC, and Cr₃C₂, MoC, SiC, and TaC, may be used if it is a ceramic. In addition, it is also possible to use nitrides, such as TiN and SiN, and oxides, such as Al₂O₃. In addition, when an insulating material is used, the same effects can be acquired by injecting a large amount of electrically conductive Si, that is, performing a sufficient amount of doping for easy current flowing, so that the electrical conductivity can be ensured.

While the effects of an electrode in which Si is mixed with a hard material have been described, it has been found that the face becomes smooth by injecting Si and the performance of the Si surface layer is exhibited accordingly. A prerequisite for the surface layer with the performance obtained herein is that an appropriate surface layer after an appropriate processing time elapses is formed. As conditions for forming an appropriate surface layer, an indicator regarding how to decide a processing time is necessary similar to the first embodiment. However, since it is important to insert Si into the surface layer, it is basically decided in the same manner as described in the first embodiment.

That is, in order to decide an appropriate processing time, it is preferable to find out a timing at which the surface roughness is reduced as processing proceeds and set the processing time as an appropriate processing time. Although the rate of Si contained in the surface layer becomes smaller than that in the case of the first embodiment since a hard material is mixed in the electrode, the tendency is the same. The surface roughness is large at first, and the surface roughness is gradually decreased. If the processing is continued for a long period of time, the surface roughness is increased again.

Since a point at which the surface roughness is reduced is an appropriate point of time, it is undoubtedly possible to use a method of checking a change in the surface roughness while performing processing for an appropriate processing time and of ending the processing at a timing at which the surface roughness is reduced. Rather than this, however, a method is thought to be practical in which how much time or how many electrical discharge pulses are to be generated for appropriate processing is determined under the conditions decided in advance and a processing time corresponding to the actual processing area is set to the time at which the surface roughness is reduced as an optimal processing time. Alternatively, a method is also possible in which there is conversion into an amount, which indicates how much the electrode is consumed in the case of an optimal processing time, in advance and this is managed as the amount of consumption of an electrode.

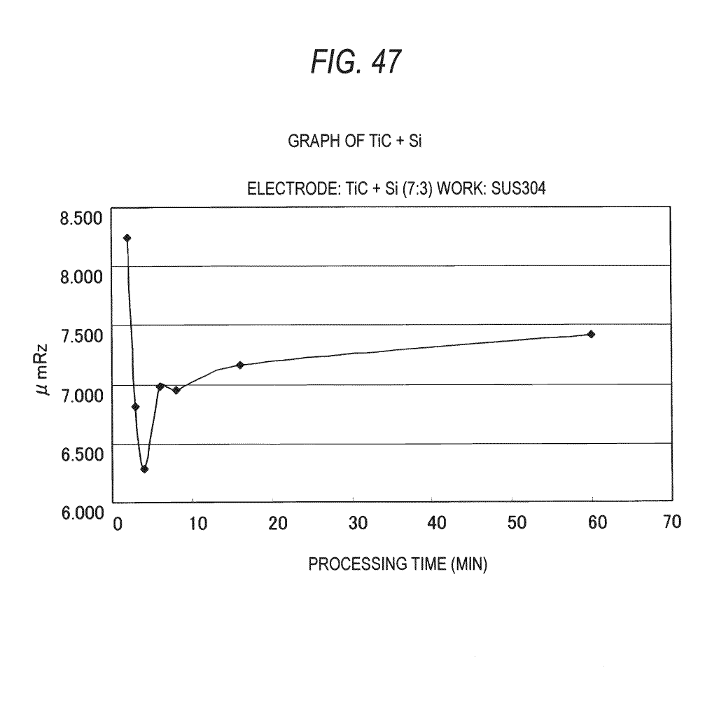

Although it was described above and will be described below, a graph of processing time and transition of the surface roughness when the TiC+Si (7:3) electrode is used is shown in FIG. 47.

The processing was performed under the setting conditions of an electrode area of 4 mm×11 mm, a current value of a current pulse ie=8 A, a pulse width te=4 μs, and an electrical discharge pause time to =32 μs.

That is, the energy of a pulse was in a condition of about 32 A·μs. The base material was SUS304. As can be seen from the graph in the drawing, the surface roughness had a minimum value at the processing time of 4 minutes. Accordingly, a good result was also obtained in a corrosion test. At the processing time of 3 minutes to 8 minutes, good corrosion resistance was confirmed. If it is taken into consideration that the electrode area is small and a variation in processing time is large, it can also be seen that high film performance is obtained at about ½ to twice the optimal value of the processing time.

In the case of an electrode material with Si of 100%, although the surface roughness did not increase rapidly even if the processing time became long when it was processed on SUS304, a phenomenon in which the surface roughness increased occurred in TiC+Si. The reason was that a crack was generated on the surface due to an increase in processing time. Presumably, if TiC is injected into an electrode and accordingly, into the surface layer, a crack is generated more easily than in the case of Si single substance and as a result, the surface roughness becomes worse.

Although details beyond this are not repeated since they are described in the first embodiment, other portions are almost the same as in the first embodiment.

### INDUSTRIAL APPLICABILITY

The electrical discharge surface treatment method related to the present invention is useful for applications to corrosion-resistant and erosion-resistant parts.

### REFERENCE SIGNS LIST

1: electrode
2: work piece
3: machining fluid
4: DC power supply
5: switching element
6: current limiting resistor
7: control circuit
8: electrical discharge detecting circuit

1. An electrical discharge surface treatment method of forming a surface layer on a work piece surface by making pulsed electrical discharge repeatedly occur between a work piece and an electrode for electrical discharge surface treatment, for which a compact formed by powder obtained by mixing 20 wt % or more of silicon with powder of a hard material or a solid body of silicon is used, so that the electrode material is moved to the work piece, comprising:
a processing time decision step of observing an electrical discharge treatment surface formed on the work piece surface by the electrical discharge and deciding the electrical discharge surface treatment end time in a process where surface roughness formed by the electrical discharge on the electrical discharge treatment surface acquired from the observation result is increased and is then decreased,
wherein
the electrical discharge surface treatment between the electrode and the work piece is executed for only the processing time set in the processing time decision step.

2. The electrical discharge surface treatment method according to claim 1,
wherein in the processing time decision step, a point of time at which the surface roughness is not reduced in the process where the surface roughness of the electrical discharge treatment surface is increased and is then decreased is set as the electrical discharge surface treatment end time.

3. The electrical discharge surface treatment method according to claim 1,
wherein in the processing time decision step, surface roughness at a point of time at which the surface roughness is not reduced in the process where the surface roughness of the electrical discharge treatment surface is increased and is then decreased is stored, and the electrical discharge surface treatment end time is when the surface roughness reaches a range of surface roughness which is 1.5 times the surface roughness.

4. The electrical discharge surface treatment method according to claim 1,
wherein in the processing time decision step, assuming that a point of time at which the surface roughness is not reduced in the process where the surface roughness of the electrical discharge treatment surface is increased and is then decreased is set as a reference and an elapsed time up to the reference is T0, the electrical discharge surface treatment end time is set in a range of 1/2T0 or more and 2T0 or less.

5. The electrical discharge surface treatment method according to claim 1,
wherein in the processing time decision step, assuming that an electrical discharge pulse counting means for counting the number of electrical discharge pulses is provided, a point of time at which the surface roughness is not reduced in the process where the surface roughness of the electrical discharge treatment surface is increased and is then decreased is set as a reference, and an elapsed time up to the reference is T0, the number of cumulative electrical discharge pulses N0 up to the elapsed time T0 is calculated, and the electrical discharge surface treatment end time is set in a range of 1/2N0 or more and 2N0 or less.

6. The electrical discharge surface treatment method according to claim 1,
wherein in the processing time decision step, a point of time at which a recess amount of the work piece by electrical discharge surface treatment becomes a predetermined amount in the process where the surface roughness of the electrical discharge treatment surface is increased and is then decreased is set as the electrical discharge surface treatment end time.

7. The electrical discharge surface treatment method according to claim 6,
wherein the predetermined amount of the recess amount of the work piece by electrical discharge surface treatment is equal to or larger than 10 μm.

8. The electrical discharge surface treatment method according to claim 1,
wherein a reference amount of consumption of the electrode for electrical discharge surface treatment based on processing for a processing time decided in the processing time decision step is calculated in advance, and
in an electrical discharge surface treatment step, the amount of consumption of the electrode for electrical discharge surface treatment is checked and processing is ended when the amount of consumption of the electrode reaches the reference amount of consumption calculated in advance.

9. The electrical discharge surface treatment method according to claim 1,
wherein an electrical discharge treatment surface is observed from the surface of the work piece using a laser microscope.

10. The electrical discharge surface treatment method according to claim 1,
wherein processing conditions in the electrical discharge surface treatment are to repeatedly generate an electrical discharge pulse, the value of time integral of a current value of an electrical discharge pulse being in a range of 30 to 80 A·μs.
